(19) United States
(12) Patent Application Publication
(10) Pub. No.: US 2024/0416532 A1
(43) Pub. Date: Dec. 19, 2024

(54) SYSTEMS AND METHODS FOR TRANSFERRING FREE FLOWING MATERIAL AND FACILITATING THE REACTION THEREOF

(71) Applicant: THE REGENTS OF THE UNIVERSITY OF COLORADO, A BODY CORPORATE, Denver, CO (US)

(72) Inventors: Kailey E. Shara, Boulder, CO (US); Carson J. Bruns, Boulder, CO (US); Andrew J. Plum, Lakewood, CO (US); Marshall T. Graybill, Glenwood Spring, CO (US)

(21) Appl. No.: 18/702,885

(22) PCT Filed: Oct. 20, 2022
(86) PCT No.: PCT/US2022/078474

§ 371 Date: Apr. 19, 2024

Related U.S. Application Data
(60) Provisional application No. 63/257,799, filed on Oct. 20, 2021.
(60) Provisional application No. 63/275,871, filed on Nov. 4, 2021.

(51) Int. Cl. B25J 15/10; B25J 15/04

(52) U.S. Cl. CPC B25J 15/10; B25J 15/0425

(57) ABSTRACT

Various implementations include a device for transferring free-flowing material. The device includes a gantry, an arm, a gripper, and a tool head. The arm has a longitudinal axis, a first arm portion, a second arm portion spaced apart from the first arm portion along the arm longitudinal axis, and a middle arm portion disposed between the first arm portion and the second arm portion. The middle arm portion is rotatably coupled to the gantry. Various implementations include a reactor system. The reactor system includes a reactor core and an outer support structure. The reactor core is configured to receive one or more containers for containing a chemical reaction.

### CROSS REFERENCE TO RELATED APPLICATIONS

This application claims priority to U.S. Provisional Application No. 63/257,799, filed Oct. 20, 2021, and U.S. Provisional Application No. 63/275,871, filed Nov. 4, 2021, the disclosures of which are hereby incorporated by reference in their entireties.

### BACKGROUND

Raw materials, or “precursors,” in a chemical reaction may be of little value on their own, but chemical reactors allow them to be transformed into high-value items such as life-saving pharmaceutical drugs and materials for electronic components, or common consumer-destined products like dyes, food additives, and adhesives. Chemical reactions are usually tested on a smaller scale (potentially only milligrams of material) and then successively scaled up to production on the order of kilograms or tons. This small-scale testing phase of research can be tedious because of the large amount of skilled human labor involved, often resulting in poor experimental reproducibility. Traditional reactions also expose lab personnel to potentially hazardous materials and require extensive use of safety equipment.

Thus, there is a need for a system for performing chemical reactions through a reliable automated process that minimizes human exposure and increases laboratory efficiency.

### SUMMARY

Various implementations include a device for transferring free-flowing material. The device includes a gantry, an arm, a gripper, and a tool head. The arm has a longitudinal axis, a first arm portion, a second arm portion spaced apart from the first arm portion along the arm longitudinal axis, and a middle arm portion disposed between the first arm portion and the second arm portion. The middle arm portion is rotatably coupled to the gantry.

In some implementations, the tool is an auger and the tool head motor is configured to rotate the auger about an auger longitudinal axis. In some implementations, the system further comprises a work surface defining a surface plane. The arm is movable along an x-axis parallel to the surface plane and along a z-axis perpendicular to the surface plane. The middle arm portion is rotatably coupled to the gantry such that the arm longitudinal axis is perpendicular to the z-axis. In some implementations, the tool head is removably coupled to the second arm portion. In some implementations, the tool head defines one or more head coupling openings. The device further comprises one or more head coupling protrusions coupled to the second arm portion. Each of the one or more head coupling protrusions is configured to be disposed within a different one of the one or more head coupling openings to removably couple the tool head to the second arm portion.

In some implementations, the one or more head coupling openings and the tool coupling portion are defined by a first head side of the tool head. The tool head further includes a rotatable locking plate, the locking plate defining one or more plate openings sized to receive the one or more head coupling protrusions. The locking plate is rotatable from a locked position to an unlocked position. The one or more head coupling protrusions are movable through the one or more plate openings into the one or more plate openings or out of the one or more plate openings in the unlocked position, and the one or more head coupling protrusions are blocked from moving through the one or more plate openings into the one or more plate openings or out of the one or more plate openings in the locked position. The tool head includes a guide element that is slidable by a ramp to move the locking plate between the locked position and the unlocked position. The tool coupling portion includes a cam and thruster mechanism for coupling the tool coupling portion to the tool. The two or more fingers are axially movable along the gripper axis.

In some implementations, the system further includes a gripper actuator for causing the two or more fingers to axially move along the gripper axis. The gripper is movably coupled to the first arm portion by a gripper bearing such that the two or more fingers are axially movable along the gripper axis. A gripper spring has a first spring end and a second spring end opposite the first spring end. The first spring end is statically coupled to the first arm portion and the second spring end is statically coupled to the gripper. In some implementations, the spring is a first spring, the device further comprises a second spring having a first spring end and a second spring end opposite the first spring end. The first spring end of the second spring is statically coupled to the first arm portion and the second spring end of the second spring is coupled to the gripper. The first spring and the second spring bias the gripper in opposite directions. The two or more fingers are rotatable about the gripper axis.

In some implementations, the system further includes a work surface defining a surface plane and an uncapping station disposed on the work surface, the uncapping station including an uncapping axis and one or more uncapping fingers radially movable relative to the uncapping axis between a first position and a second position. At least two of the two or more uncapping fingers are closer to the uncapping axis in the second position than in the first position. The two or more fingers are rotatable about the uncapping axis. In some implementations, the gripper includes a worm gear, a flange nut, and a vertical displacement device. The worm gear may be coupled to the flange nut and the flange nut engaged with the vertical displacement device such that rotation of the worm gear causes the vertical displacement device to move each of the two or more fingers between the first position and the second position. In some implementations, the two or more fingers comprises four fingers.

In some implementations, the system further includes a range sensor coupled to the second arm portion for determining the distance from the free-flowing material to the range sensor. In some implementations, the range sensor is coupled to the tool head. In some implementations, the range sensor comprises a time-of-flight sensor. In some implementations, the system further includes a weighing scale having a mass-sensitive portion and a non-mass-sensitive portion. The non-mass-sensitive portion is coupled to the second arm portion and the mass-sensitive portion is coupled to the tool head.

In some implementations, the system further includes a current sensor for sensing current flow of the tool head motor and a processor in electrical communication with the current sensor and a memory. The processor executes computer-readable instructions stored on the memory, the instructions causing the processor to: receive a first mass measurement from the weighing scale, energize the tool head motor to cause the tool to collect a portion of the free-flowing material, receive sensor data from the current sensor, deenergize the tool head motor, determine an amount of time the tool head motor was energized or the number of motor rotations, receive a second mass measurement from the weighing scale, and determine a flow consistency property of the free-flowing material based on the amount of time the tool head motor was energized or the number of motor rotations, the difference between the first mass measurement and the second mass measurement, and the sensor data from the current sensor.

In some implementations, the system further includes a first infrared communication system in electrical communication with the processor and a second infrared communication system coupled to and in electrical communication with the tool head motor. Each of the first infrared communication system and the second infrared communication system include a transmitter and a receiver.

In some implementations, the system further comprises a processor in electrical communication with a memory. The processor executes computer-readable instructions stored on the memory, the instructions causing the processor to: receive a first mass measurement from the weighing scale, move the arm along the z-axis such that the tool contacts the free-flowing material within a container, energize the tool head motor to cause the tool to collect a portion of the free-flowing material, deenergize the tool head motor, move the arm along the z-axis such that the tool is spaced apart from the free-flowing material within the container, determine a first amount of time the tool head motor was energized or the number of motor rotations, receive a second mass measurement from the weighing scale, and determine a first collection rate of the free-flowing material by the tool based on the amount of time the tool head motor was energized, or the number of motor rotations, and the difference between the first mass measurement and the second mass measurement.

In some implementations, the instructions cause the processor to: move the arm along the z-axis such that the tool contacts the free-flowing material within the container, energize the tool head motor to cause the tool to collect another portion of the free-flowing material, deenergize the tool head motor, move the arm along the z-axis such that the tool is spaced apart from the free-flowing material within the container, determine a second amount of time the tool head motor was energized or the number of motor rotations, receive a third mass measurement from the weighing scale, and determine a second collection rate of the free-flowing material by the tool based on the second amount of time the tool head motor was energized, or the number of motor rotations, and the difference between the second mass measurement and the third mass measurement.

In some implementations, the system further includes a first infrared communication system in electrical communication with the processor and a second infrared communication system coupled to and in electrical communication with the tool head motor. Each of the first infrared communication system and the second infrared communication system include a transmitter and a receiver. In some implementations, the system further includes a first wireless power transmission (WPT) coil and a second WPT coil. The first WPT coil is coupled to the second arm portion and the second WPT coil is coupled to the tool head. The first WPT coil is spaced apart from the second WPT coil, and the first WPT coil is energizable to cause current to flow through the second WPT coil. A battery in electrical communication with the second WPT coil such that the current to flow through the second WPT coil charges the battery. In some implementations, the first WPT coil is configured to deenergize when the weighing scale is in use. In some implementations, a shaker is coupled to the tool head for causing vibrations in the tool.

Various implementations include a weighing device. The weighing device includes a weighing scale having a mass-sensitive portion and a non-mass-sensitive portion, The mass-sensitive portion is coupled to a tool head. The weighing device further includes a first wireless power transmission (WPT) coil and a second WPT coil. The first WPT coil is coupled to the mass-sensitive portion and the second WPT coil is coupled to the non-mass-sensitive portion. Further, the first WPT coil is spaced apart from the second WPT coil, and the first WPT coil is energizable to cause current to flow through the second WPT coil and to the tool head.

In some implementations, the system further includes a battery in electrical communication with the second WPT coil such that the current to flow through the second WPT coil charges the battery. The first WPT coil is configured to deenergize when the weighing scale is in use. In some implementations, the tool head includes a tool head motor and a tool coupling portion that is couplable to a tool. The current to flow through the second WPT coil flows to the tool head motor.

In some implementations, the tool is an auger. The tool head motor is configured to rotate the auger about an auger longitudinal axis. The tool head is removably coupled to the mass-sensitive portion. The tool head defines one or more head coupling openings. In some implementations, the device further includes one or more head coupling protrusions coupled to the mass-sensitive portion. Each of the one or more head coupling protrusions is configured to be disposed within a different one of the one or more head coupling openings to removably couple the tool head to the mass-sensitive portion.

In some implementations, the one or more head coupling openings and the tool coupling portion are defined by a first head side. The tool head further includes a rotatable locking plate, the locking plate defining one or more plate openings sized to receive the one or more head coupling protrusions. The locking plate is rotatable from a locked position to an unlocked position. The one or more head coupling protrusions are movable through the one or more plate openings into the one or more plate openings or out of the one or more plate openings in the unlocked position, and the one or more head coupling protrusions are blocked from moving through the one or more plate openings into the one or more plate openings or out of the one or more plate openings in the locked position.

In some implementations, the tool head includes a guide element that is slidable by a ramp to move the locking plate between the locked position and the unlocked position. The tool coupling portion includes a cam and thruster mechanism for coupling the tool coupling portion to the tool. In some implementations, the system further includes a range sensor coupled to the mass-sensitive portion for determining the distance from a free-flowing material to the range sensor. The range sensor is coupled to the tool head. The range sensor comprises a time-of-flight sensor.

In some implementations, the system further includes a current sensor for sensing current flow of the tool head motor and a processor in electrical communication with the current sensor and a memory. The processor executes computer-readable instructions stored on the memory, the instructions causing the processor to: receive a first mass measurement from the weighing scale, energize the tool head motor to cause the tool to collect a portion of a free-flowing material, receive sensor data from the current sensor, deenergize the tool head motor, determine an amount of time the tool head motor was energized or the number of motor rotations, receive a second mass measurement from the weighing scale, and determine a flow consistency property of the free-flowing material based on the amount of time the tool head motor was energized or the number of motor rotations, the difference between the first mass measurement and the second mass measurement, and the sensor data from the current sensor.

In some implementations, the system further includes a first infrared communication system in electrical communication with the processor and a second infrared communication system coupled to and in electrical communication with the tool head motor. Each of the first infrared communication system and the second infrared communication system include a transmitter and a receiver.

In some implementations, the system further includes a processor in electrical communication with a memory. The processor executes computer-readable instructions stored on the memory, the instructions causing the processor to: receive a first mass measurement from the weighing scale, cause the tool head to move such that the tool contacts a free-flowing material within a container, energize the tool head motor to cause the tool to collect a portion of the free-flowing material, deenergize the tool head motor, cause the tool head to move such that the tool is spaced apart from the free-flowing material within the container, determine a first amount of time the tool head motor was energized or the number of motor rotations, receive a second mass measurement from the weighing scale, and determine a first collection rate of the free-flowing material by the tool based on the amount of time the tool head motor was energized, or the number of motor rotations, and the difference between the first mass measurement and the second mass measurement.

In some implementations, the instructions cause the processor to: cause the tool head to move such that the tool contacts the free-flowing material within the container, energize the tool head motor to cause the tool to collect another portion of the free-flowing material, deenergize the tool head motor, cause the tool head to move such that the tool is spaced apart from the free-flowing material within the container, determine a second amount of time the tool head motor was energized or the number of motor rotations, receive a third mass measurement from the weighing scale, and determine a second collection rate of the free-flowing material by the tool based on the second amount of time the tool head motor was energized, or the number of motor rotations, and the difference between the second mass measurement and the third mass measurement.

In some implementations, the system further includes a first infrared communication system in electrical communication with the processor and a second infrared communication system coupled to and in electrical communication with the tool head motor. Each of the first infrared communication system and the second infrared communication system include a transmitter and a receiver.

Various implementations include a tool head removal device. The tool head removal device includes a base and a tool head. The base includes one or more head coupling protrusions. The tool head is removably coupled to the base. The tool head includes a tool head motor and a tool coupling portion that is couplable to a tool. The tool head defines one or more head coupling openings. Each of the one or more head coupling protrusions is configured to be disposed within a different one of the one or more head coupling openings to removably couple the tool head to the base.

In some implementations, the one or more head coupling openings and the tool coupling portion are defined by a first head side of the tool head. The tool head further includes a rotatable locking plate, the locking plate defining one or more plate openings sized to receive the one or more head coupling protrusions. The locking plate is rotatable from a locked position to an unlocked position. The one or more head coupling protrusions are movable through the one or more plate openings into the one or more plate openings or out of the one or more plate openings in the unlocked position, and the one or more head coupling protrusions are blocked from moving through the one or more plate openings into the one or more plate openings or out of the one or more plate openings in the locked position.

In some implementations, the tool head includes a guide element that is slidable by a ramp to move the locking plate between the locked position and the unlocked position. In some implementations, the tool coupling portion includes a cam and thruster mechanism for coupling the tool coupling portion to the tool. In some implementations, the system further includes a range sensor coupled to the base for determining the distance from a free-flowing material to the range sensor. The range sensor comprises a time-of-flight sensor. In some implementations, a range sensor is coupled to the tool head for determining the distance from a free-flowing material to the range sensor. The range sensor comprises a time-of-flight sensor. In some implementations, the tool is an auger. The tool head motor is configured to rotate the auger about an auger longitudinal axis. In some implementations, the base is an end portion of an arm coupled to a movable positioning member. In some implementations, the system further includes a work surface defining a surface plane. A gantry includes a movable positioning member configured to move along an x-axis parallel to the surface plane. The arm is coupled to the movable positioning member. The arm is configured to move vertically along a z-axis perpendicular to the surface plane and rotatably about the z-axis.

In some implementations, the system further includes a weighing scale having a mass-sensitive portion and a non-mass-sensitive portion. The non-mass-sensitive portion is coupled to the base and the mass-sensitive portion is coupled to the one or more head coupling protrusions.

In some implementations, the system further includes a current sensor for sensing current flow of the tool head motor and a processor in electrical communication with the current sensor and a memory. The processor executes computer-readable instructions stored on the memory, the instructions causing the processor to: receive a first mass measurement from the weighing scale, energize the tool head motor to cause the tool to collect a portion of a free-flowing material, receive sensor data from the current sensor, deenergize the tool head motor, determine an amount of time the tool head motor was energized or the number of motor rotations, receive a second mass measurement from the weighing scale, and determine a flow consistency property of the free-flowing material based on the amount of time the tool head motor was energized or the number of motor rotations, the difference between the first mass measurement and the second mass measurement, and the sensor data from the current sensor.

In some implementations, the system further includes a first infrared communication system in electrical communication with the processor and a second infrared communication system coupled to and in electrical communication with the tool head motor. Each of the first infrared communication system and the second infrared communication system include a transmitter and a receiver.

In some implementations, the system further includes a processor in electrical communication with a memory. The processor executes computer-readable instructions stored on the memory, the instructions causing the processor to: receive a first mass measurement from the weighing scale, cause the tool head to move such that the tool contacts a free-flowing material within a container, energize the tool head motor to cause the tool to collect a portion of the free-flowing material, deenergize the tool head motor, cause the tool head to move such that the tool is spaced apart from the free-flowing material within the container, determine a first amount of time the tool head motor was energized or the number of motor rotations, receive a second mass measurement from the weighing scale, and determine a first collection rate of the free-flowing material by the tool based on the amount of time the tool head motor was energized, or the number of motor rotations, and the difference between the first mass measurement and the second mass measurement.

In some implementations, the instructions cause the processor to: cause the tool head to move such that the tool contacts the free-flowing material within the container, energize the tool head motor to cause the tool to collect another portion of the free-flowing material, deenergize the tool head motor, cause the tool head to move such that the tool is spaced apart from the free-flowing material within the container, determine a second amount of time the tool head motor was energized or the number of motor rotations, receive a third mass measurement from the weighing scale, and determine a second collection rate of the free-flowing material by the tool based on the second amount of time the tool head motor was energized, or the number of motor rotations, and the difference between the second mass measurement and the third mass measurement.

In some implementations, the system further includes a first infrared communication system in electrical communication with the processor and a second infrared communication system coupled to and in electrical communication with the tool head motor. Each of the first infrared communication system and the second infrared communication system include a transmitter and a receiver.

In some implementations, the system further includes a first wireless power transmission (WPT) coil and a second WPT coil. The first WPT coil is coupled to the base and the second WPT coil is coupled to the tool head. The first WPT coil is spaced apart from the second WPT coil, and the first WPT coil is energizable to cause current to flow through the second WPT coil. In some implementations, the system further includes a battery in electrical communication with the second WPT coil such that the current to flow through the second WPT coil charges the battery. The first WPT coil is configured to deenergize when the weighing scale is in use. In some implementations, the system further includes a shaker coupled to the tool head for causing vibrations in the tool.

Various implementations include a tool removal device. The tool removal device includes a base, a tool, and a tool head coupled to the base. The tool head includes a tool head motor and a tool coupling portion that is couplable to the tool. The tool coupling portion includes a cam and thruster mechanism for coupling the tool coupling portion to the tool.

In some implementations, the tool head is removably coupled to the second arm portion. In some implementations, the tool head defines one or more head coupling openings. The device further comprises one or more head coupling protrusions coupled to the base, wherein each of the one or more head coupling protrusions is configured to be disposed within a different one of the one or more head coupling openings to removably couple the tool head to the base. The one or more head coupling openings and the tool coupling portion are defined by a first head side of the tool head. The tool head further includes a rotatable locking plate, the locking plate defining one or more plate openings sized to receive the one or more head coupling protrusions. The locking plate is rotatable from a locked position to an unlocked position. The one or more head coupling protrusions are movable through the one or more plate openings into the one or more plate openings or out of the one or more plate openings in the unlocked position, and the one or more head coupling protrusions are blocked from moving through the one or more plate openings into the one or more plate openings or out of the one or more plate openings in the locked position.

In some implementations, the tool head includes a guide element that is slidable by a ramp to move the locking plate between the locked position and the unlocked position. In some implementations, the system further includes a range sensor coupled to the base for determining the distance from a free-flowing material to the range sensor. In some implementations, the range sensor comprises a time-of-flight sensor. In some implementations, a range sensor is coupled to the tool head for determining the distance from a free-flowing material to the range sensor. In some implementations, the tool is an auger. The tool head motor is configured to rotate the auger about an auger longitudinal axis. In some implementations, the base is an end portion of an arm coupled to a movable positioning member. In some implementations, the system further includes a work surface defining a surface plane. A gantry includes a movable positioning member configured to move along an x-axis parallel to the surface plane. The arm is coupled to the movable positioning member. The arm is configured to move vertically along a z-axis perpendicular to the surface plane and rotatably about the z-axis.

In some implementations, the system further includes a weighing scale having a mass-sensitive portion and a non-mass-sensitive portion. The non-mass-sensitive portion is coupled to the base and the mass-sensitive portion is coupled to the tool head.

In some implementations, the system further includes a current sensor for sensing current flow of the tool head motor and a processor in electrical communication with the current sensor and a memory. The processor executes computer-readable instructions stored on the memory, the instructions causing the processor to: receive a first mass measurement from the weighing scale, energize the tool head motor to cause the tool to collect a portion of a free-flowing material, receive sensor data from the current sensor, deenergize the tool head motor, determine an amount of time the tool head motor was energized or the number of motor rotations, receive a second mass measurement from the weighing scale, and determine a flow consistency property of the free-flowing material based on the amount of time the tool head motor was energized or the number of motor rotations, the difference between the first mass measurement and the second mass measurement, and the sensor data from the current sensor.

In some implementations, the system further includes a first infrared communication system in electrical communication with the processor and a second infrared communication system coupled to and in electrical communication with the tool head motor. Each of the first infrared communication system and the second infrared communication system include a transmitter and a receiver.

In some implementations, the system further includes a processor in electrical communication with a memory. The processor executes computer-readable instructions stored on the memory, the instructions causing the processor to: receive a first mass measurement from the weighing scale, cause the tool head to move such that the tool contacts a free-flowing material within a container, energize the tool head motor to cause the tool to collect a portion of the free-flowing material, deenergize the tool head motor, cause the tool head to move such that the tool is spaced apart from the free-flowing material within the container, determine a first amount of time the tool head motor was energized or the number of motor rotations, receive a second mass measurement from the weighing scale, and determine a first collection rate of the free-flowing material by the tool based on the amount of time the tool head motor was energized, or the number of motor rotations, and the difference between the first mass measurement and the second mass measurement.

In some implementations, the instructions cause the processor to: cause the tool head to move such that the tool contacts the free-flowing material within the container, energize the tool head motor to cause the tool to collect another portion of the free-flowing material, deenergize the tool head motor, cause the tool head to move such that the tool is spaced apart from the free-flowing material within the container, determine a second amount of time the tool head motor was energized or the number of motor rotations, receive a third mass measurement from the weighing scale, and determine a second collection rate of the free-flowing material by the tool based on the second amount of time the tool head motor was energized, or the number of motor rotations, and the difference between the second mass measurement and the third mass measurement.

In some implementations, the system further includes a first infrared communication system in electrical communication with the processor and a second infrared communication system coupled to and in electrical communication with the tool head motor. Each of the first infrared communication system and the second infrared communication system include a transmitter and a receiver.

In some implementations, the system further includes a first wireless power transmission (WPT) coil and a second WPT coil. The first WPT coil is coupled to the base and the second WPT coil is coupled to the tool head. The first WPT coil is spaced apart from the second WPT coil, and the first WPT coil is energizable to cause current to flow through the second WPT coil. In some implementations, the system further includes a battery in electrical communication with the second WPT coil such that the current to flow through the second WPT coil charges the battery. The first WPT coil is configured to deenergize when the weighing scale is in use. In some implementations, the system further includes a shaker coupled to the tool head for causing vibrations in the tool.

Various implementations include a gripping device. The gripping device includes a base, a gripper, and a gripper spring. The gripper includes two or more fingers movably coupled to the base relative to a gripper axis. The two or more fingers are radially movable relative to the gripper axis between a first position and a second position. At least two of the two or more fingers are closer to the gripper axis in the second position than in the first position. The two or more fingers are axially movable along the gripper axis. The gripper spring includes a first spring end and a second spring end opposite the first spring end. The first spring end is statically coupled to the base and the second spring end is statically coupled to the gripper.

In some implementations, the system further includes a gripper actuator for causing the two or more fingers to axially move along the gripper axis. In some implementations, the gripper is movably coupled to the base by a gripper bearing such that the two or more fingers are axially movable along the gripper axis.

In some implementations, the spring is a first spring, the device further comprising a second spring having a first spring end and a second spring end opposite the first spring end. The first spring end of the second spring is statically coupled to the base and the second spring end of the second spring is coupled to the gripper. The first spring and the second spring bias the gripper in opposite directions. In some implementations, the two or more fingers are rotatable about the gripper axis.

In some implementations, the system further includes a work surface defining a surface plane; and an uncapping station disposed on the work surface. The uncapping station includes an uncapping axis and one or more uncapping fingers radially movable relative to the uncapping axis between a first position and a second position. At least two of the two or more uncapping fingers are closer to the uncapping axis in the second position than in the first position. The two or more fingers are rotatable about the uncapping axis. In some implementations, the gripper includes a worm gear, a flange nut, and a vertical displacement device. The worm gear may be coupled to the flange nut and the flange nut engaged with the vertical displacement device such that rotation of the worm gear causes the vertical displacement device to move each of the two or more fingers between the first position and the second position. In some implementations, the two or more fingers comprises four fingers. In some implementations, the base is an end portion of an arm coupled to a movable positioning member. In some implementations, the system further includes a work surface defining a surface plane. A gantry includes a movable positioning member configured to move along an x-axis parallel to the surface plane. The arm is coupled to the movable positioning member. The arm is configured to move vertically along a z-axis perpendicular to the surface plane and rotatably about the z-axis.

Various implementations include an uncapping system. The uncapping system includes a work surface defining a surface plane, a gripping device, and an uncapping station. The gripping device includes a base and a gripper. The gripper includes two or more fingers movably coupled to the base relative to a gripper axis. The two or more fingers are radially movable relative to the gripper axis between a first position and a second position. At least two of the two or more fingers are closer to the gripper axis in the second position than in the first position. The uncapping station is disposed on the work surface. The uncapping station includes an uncapping axis and one or more uncapping fingers radially movable relative to the uncapping axis between a first position and a second position. At least two of the two or more uncapping fingers are closer to the uncapping axis in the second position than in the first position. The two or more fingers are rotatable about the uncapping axis.

In other implementations, the two or more fingers are axially movable along the gripper axis. In some implementations, the system further includes a gripper actuator for causing the two or more fingers to axially move along the gripper axis. The gripper is movably coupled to the base by a gripper bearing such that the two or more fingers are axially movable along the gripper axis. In some implementations, the system further includes a gripper spring having a first spring end and a second spring end opposite the first spring end. The first spring end is statically coupled to the first arm portion and the second spring end is statically coupled to the gripper.

In some implementations, the spring is a first spring, the device further comprising a second spring having a first spring end and a second spring end opposite the first spring end. The first spring end of the second spring is statically coupled to the base and the second spring end of the second spring is coupled to the gripper. The first spring and the second spring bias the gripper in opposite directions. The two or more fingers are rotatable about the gripper axis. In some implementations, the gripper includes a worm gear, a flange nut, and a vertical displacement device. The worm gear may be coupled to the flange nut and the flange nut engaged with the vertical displacement device such that rotation of the worm gear causes the vertical displacement device to move each of the two or more fingers between the first position and the second position. In some implementations, the two or more fingers comprises four fingers.

In some implementations, the base is an end portion of an arm coupled to a movable positioning member. In some implementations, the system further includes a work surface defining a surface plane and a gantry comprising a movable positioning member configured to move along an x-axis parallel to the surface plane. The arm is coupled to the movable positioning member. The arm is configured to move vertically along a z-axis perpendicular to the surface plane and rotatably about the z-axis.

Various implementations include a reactor system. The reactor system includes a reactor core and an outer support structure. The reactor core is configured to receive one or more containers for containing a chemical reaction. The reactor core includes a first core side and a second core side opposite and spaced apart from the first core side. The outer support structure includes a frame having a first frame portion, a second frame portion spaced apart and opposite the first frame portion, and at least one side frame portion extending from the first frame portion to the second frame portion. The outer support structure further includes a frame longitudinal axis extending from the first frame portion to the second frame portion. The outer support structure further includes a first resilient member extending from the first frame portion to the first core side. The outer support structure further includes a second frame resilient member extending from the second frame portion to the second core side such that the reactor core is disposed between the first frame portion and the second frame portion and is suspended by the first frame resilient member and the second frame resilient member. The outer support structure further includes at least one actuator extending from the frame to the reactor core. The actuator is movable from an extended position to a retracted position to cause the reactor core to move radially relative to the frame longitudinal axis.

In some implementations, the two or more fingers are axially movable along the gripper axis. In some implementations, the system further includes a gripper actuator for causing the two or more fingers to axially move along the gripper axis. The gripper is movably coupled to the base by a gripper bearing such that the two or more fingers are axially movable along the gripper axis. In some implementations, the system further includes a gripper spring having a first spring end and a second spring end opposite the first spring end. The first spring end is statically coupled to the first arm portion and the second spring end is statically coupled to the gripper. In some implementations, the spring is a first spring, and the device further includes a second spring having a first spring end and a second spring end opposite the first spring end. The first spring end of the second spring is statically coupled to the base and the second spring end of the second spring is coupled to the gripper. The first spring and the second spring bias the gripper in opposite directions. In some implementations, the two or more fingers are rotatable about the gripper axis.

In some implementations, the gripper includes a worm gear, a flange nut, and a vertical displacement device. The worm gear may be coupled to the flange nut and the flange nut engaged with the vertical displacement device such that rotation of the worm gear causes the vertical displacement device to move each of the two or more fingers between the first position and the second position. In some implementations, the two or more fingers comprises four fingers. In some implementations, the base is an end portion of an arm coupled to a movable positioning member. In some implementations, the system further includes a work surface defining a surface plane and a gantry comprising a movable positioning member configured to move along an x-axis parallel to the surface plane. The arm is coupled to the movable positioning member. The arm is configured to move vertically along a z-axis perpendicular to the surface plane and rotatably about the z-axis.

Various implementations include a reactor core. The reactor core includes a body defining a container opening for receiving a container for containing a chemical reaction. The container opening defines a container longitudinal axis. The reactor core further includes a door system. The door system includes a door, a door hinge, and a door lift. The door is for sealingly abutting a lip of an opening defined by the container disposed within the container opening. The door hinge is coupled to the door. The door lift is coupled to the door hinge such that the door is hingable by the door hinge relative to the door lift. The door lift is configured to move the door along the container longitudinal axis relative to the body.

In some implementations, the container opening is a first container opening, the body defining one or more additional container openings. The door system is a first door system, further comprising one or more additional door systems. The door of each of the one or more additional door systems is configured to sealingly abutting a lip of an opening defined by a container disposed within a different one of the one or more additional container openings.

In some implementations, the system further includes a door hinge motor for causing the door hinge to hinge the door relative to the door lift and a door lift motor for causing the door lift to move the door along the container longitudinal axis relative to the body. In some implementations the system further includes a rack and a pinion. One of the rack or the pinion are coupled to the body and the other of the pinion or the rack is coupled to the door lift.

In some implementations, the door system further comprises a door lock including a lock protrusion movable from a locked position to an unlocked position. The lock protrusion is engaged with a lock opening defined by the door to prevent hinging or movement of the door in the locked position. The lock protrusion is disengaged with the lock opening in the unlocked position. In some implementations, the door lock further includes a lock shaft having a lock longitudinal axis. The lock protrusion extends radially from the lock shaft relative to the lock longitudinal axis. The movement of the lock protrusion is circumferential rotation relative to the lock longitudinal axis.

In some implementations, the door lock further includes a lock plate defining a lock opening aligned with the container opening. The lock opening includes a retaining portion and a releasing portion. The retaining portion has a narrowest width that is narrower than a widest diameter of the container and the releasing portion has a narrowest width that is wider than the widest diameter of the container. The retaining portion of the lock opening is aligned with the container opening in the unlocked position and the releasing portion of the lock opening is aligned with the container opening in the locked position.

In some implementations, the door lock further includes a lock motor for moving the lock protrusion from the locked position to the unlocked position. In some implementations the door lock further includes a lift lock engageable with the door lift. In the locked position the lift lock is engaged with the door lift to prevent movement of the door along the container longitudinal axis relative to the body. In the unlocked position the lift lock is disengaged with the door lift.

In some implementations the system further includes an outer condenser including: a condensing fluid reservoir in thermal contact with a container when the container is disposed in the container opening; an outer condenser inlet in fluid communication with the condensing fluid reservoir; and an outer condenser outlet in fluid communication with the condensing fluid reservoir.

In some implementations, the system further includes an inner condenser comprising: a condenser coil coupled to the door such that the condenser coil is disposed within the container when the door is sealingly abutting the lip of the opening defined by the container when the container is disposed within the container opening; an inner condenser inlet in fluid communication with the condensing fluid reservoir; and an inner condenser outlet in fluid communication with the condensing fluid reservoir.

In some implementations, the system further includes one or more thermoelectric units in thermal contact with the container when the container is disposed within the container opening. In some implementations, the system further includes a temperature sensor in thermal contact with the thermoelectric unit.

In some implementations, the system further includes a heat exchanger comprising: a heat exchange fluid reservoir in thermal contact with the one or more thermoelectric units; a heat exchanger inlet in fluid communication with the heat exchange fluid reservoir; and a heat exchanger outlet in fluid communication with the heat exchange fluid reservoir.

In some implementations, the system further includes a laser device configured to emit a laser through at least a portion of the container when the container is disposed within the container opening and a photodetector for receiving the emitted laser. In some implementations, the system further includes a photo-optic circuit board for emitting light into the container when the container is disposed within the container opening. In some implementations, the photo-optic circuit board is capable of emitting a range of wavelengths of light into the container when the container is disposed within the container opening.

In some implementations, the system further includes a reactor core with a first core side and a second core side opposite and spaced apart from the first core side; and an outer support structure including: a frame having a first frame portion, a second frame portion spaced apart and opposite the first frame portion, and at least one side frame portion extending from the first frame portion to the second frame portion, a frame longitudinal axis extending from the first frame portion to the second frame portion, a first resilient member extending from the first frame portion to the first core side, a second frame resilient member extending from the second frame portion to the second core side such that the reactor core is disposed between the first frame portion and the second frame portion and is suspended by the first frame resilient member and the second frame resilient member, at least one actuator extending from the frame to the reactor core. The actuator is movable from an extended position to a retracted position to cause the reactor core to move radially relative to the frame longitudinal axis.

In some implementations, the at least one actuator comprises at least two actuators. In some implementations, the at least two actuators comprises six actuators. In some implementations the at least one actuator comprises at least one linear actuator. In some implementations the outer support structure comprises at least one cable coupling the at least one actuator to the reactor core.

In some implementations, the system further includes a processor in electrical communication with the at least three actuators and a memory. The processor executes computer-readable instructions stored on the memory, the instructions causing the processor to: send a signal to a first actuator of the at least three actuators to cause the first actuator to move from the extended position to the retracted position; send a signal to a second actuator of the at least three actuators to cause the second actuator to move from the extended position to the retracted position; send a signal to the first actuator to cause the first actuator to move from the retracted position to the extended position; send a signal to a third actuator of the at least three actuators to cause the third actuator to move from the extended position to the retracted position; send a signal to the second actuator to cause the second actuator to move from the retracted position to the extended position; and send a signal to the third actuator to cause the this actuator to move from the retracted position to the extended position.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a perspective view of an automated system of performing a chemical reaction.

FIG. 2 is a perspective view of a transfer device.

FIG. 3 is a profile view of a gripper.

FIG. 4 is a perspective view of an uncapping station.

FIG. 5 is a perspective view of a tool head.

FIG. 6 is a perspective view of the underside of a tool head.

FIG. 7 is a section view of a tool head.

FIG. 8 shows alternative tool options.

FIG. 9 is a perspective view of a tool magazine.

FIG. 10 is a perspective view of a tool head tray.

FIG. 11 is a perspective view of a reactor system.

FIG. 12 is a perspective view of a reactor core.

FIG. 13 shows a detailed views of a portion of the reactor core.

FIG. 14 shows a detailed view of a portion of the door system.

FIG. 15 shows a perspective view of a locking element of the reactor core.

FIG. 16 shows a cross section of the reactor core.

FIG. 17 shows a cross section of the reactor core.

FIG. 18 shows a heating and cooling system of a reactor core.

FIG. 19 shows a variation of the outer core with support structure.

FIG. 20 shows a variation of the reactor core and door system.

FIG. 21 shows a variation of the reactor core and door system.

FIG. 22 shows a variation of the reactor core and door system.

FIG. 23 shows a variation of the reactor core and door system.

FIG. 24a shows a step in the function of a cam and thruster mechanism.

FIG. 24b shows a step in the function of a cam and thruster mechanism.

FIG. 24c shows a step in the function of a cam and thruster mechanism.

FIG. 24d shows a step in the function of a cam and thruster mechanism.

FIG. 24e shows a step in the function of a cam and thruster mechanism.

FIG. 24f shows a step in the function of a cam and thruster mechanism.

FIG. 25a shows a solids dispensing pipette.

FIG. 25b shows a solids dispensing pipette.

FIG. 25c shows a solids dispensing pipette.

FIG. 25d shows a solids dispensing pipette.

### DETAILED DESCRIPTION

Disclosed herein are devices, systems, and methods for transferring free-flowing material (such as powdered solids) between containers. In various implementations, the devices, systems, and methods are also (or alternatively) configured for automatically performing chemical reactions, such as organic and inorganic chemical reaction. Various implementations of the devices, systems, and methods disclosed herein can be used, for example, to provide robotic handling of solid chemicals in a laboratory automation system.

According to various implementations, the systems disclosed herein may include a device for transferring free-flowing material. The device includes a gantry having a movable positioning member, an arm coupled to the movable positioning member, and a gripper and tool head, each supported by the arm. In various implementations, the device is configured such that the arm can be moved laterally (e.g., along an x-axis), vertically (e.g., along a z-axis), and rotatably (e.g., about the z-axis). In various implementations, the device is configured for transferring free-flowing material between containers (e.g., the gripper being configured to facilitate opening of a container and the tool head being configured for withdrawing (and depositing) material from (or to) a container).

In various implementations, the system may further include a weighing device for weighing the free-flowing material withdrawn by the tool. The weighing device includes a mass-sensitive portion coupled to the tool head and a non-mass sensitive portion coupled to the arm. In various implementations, the mass-sensitive portion is isolated from the rest of the arm such that accurate measurements may be taken (e.g., the mass of a chemical powder). The weighing device includes two wireless power transmission (WPT) coils spaced apart from one another. In some implementations, the WPT coils are used to provide power to the tool on the tool head while maintaining isolation of the mass-sensitive portion.

In various implementations, the system may further include a tool head removal device for switching out tool heads. The tool head includes two openings which engage with two protrusions on a base structure connected to the arm. Each protrusion is configured to slide and lock into an opening on the tool head. In various implementations, a tool head may be removed or added to the arm via the protrusions by clicking and locking into place.

In various implementations, the system may further include a tool removal device. The tool head attached to the arm is configured to engage with different tools on the bottom of the tool head. The tool head includes a coupling portion with a cam and thruster mechanism for engaging with various tools. In various implementations, the tool head can grab different tools and lock them in place or change out tools automatically (e.g., removing an auger tool and grabbing a tweezer tool).

In various implementations, the system may further include a gripping device. The gripping device includes four fingers arranged around a base configured to facilitate opening of a chemical container. The fingers move radially inward to grab the lid of a container. In various implementations, the gripping device includes a slidable engagement with the arm and two springs oriented in opposite directions. In use, the fingers hold the cap and either raise or lower as it unscrews or screws onto the chemical container.

In various implementations, the system may further include an uncapping system. The uncapping system is disposed on the work surface and is configured to hold the bottom side of a chemical container. In various implementations, the uncapping system includes four fingers radially movable to grab the chemical container. The base and the fingers of the uncapping system then rotate the chemical container (also being held by the gripping device) in order to remove or attach a lid.

Further disclosed herein are devices, systems, and methods for automatically performing chemical reactions. According to various implementations, a reactor system for automatically performing chemical reactions is disposed on the work surface. The reactor system includes a reactor core and an outer support structure.

In various implementations, the reactor system may include a reactor core. The reactor core may receive one or more containers, each of which may receive free-flowing material from a tool. In various implementations, the reactor core may further include a door system sealing each container in order to contain a chemical reaction. The door system may allow a variety of sensors and heat exchange elements to communicate with the inside of the container during a chemical reaction.

In various implementations, the reactor system may include an outer support structure surrounding the reactor core. The support structure suspends the reactor core on springs and holds it in place within the support structure frame. In various implementations, a series of actuators are attached to the outer support structure and may move the reactor core in a desired direction. In various implementations, the actuators shake or rotate the reactor core in order to mix the chemicals inside the containers.

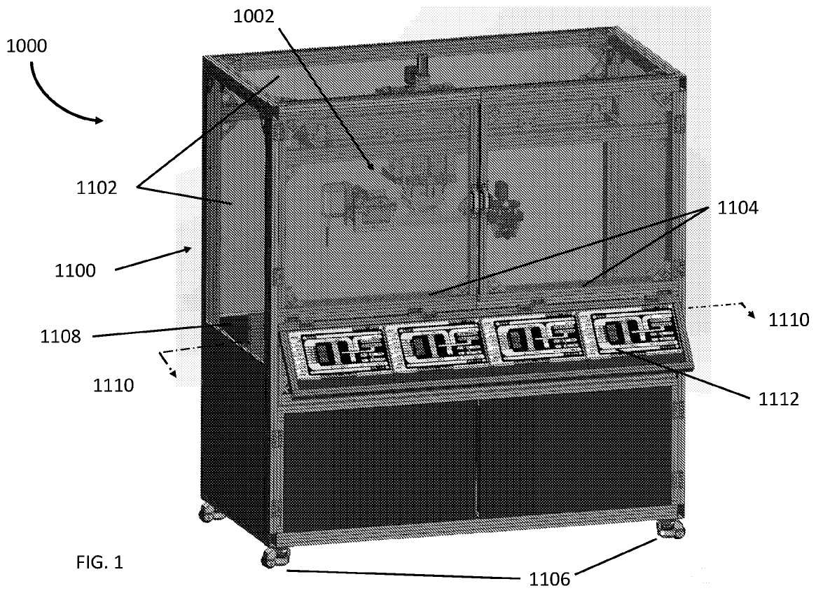

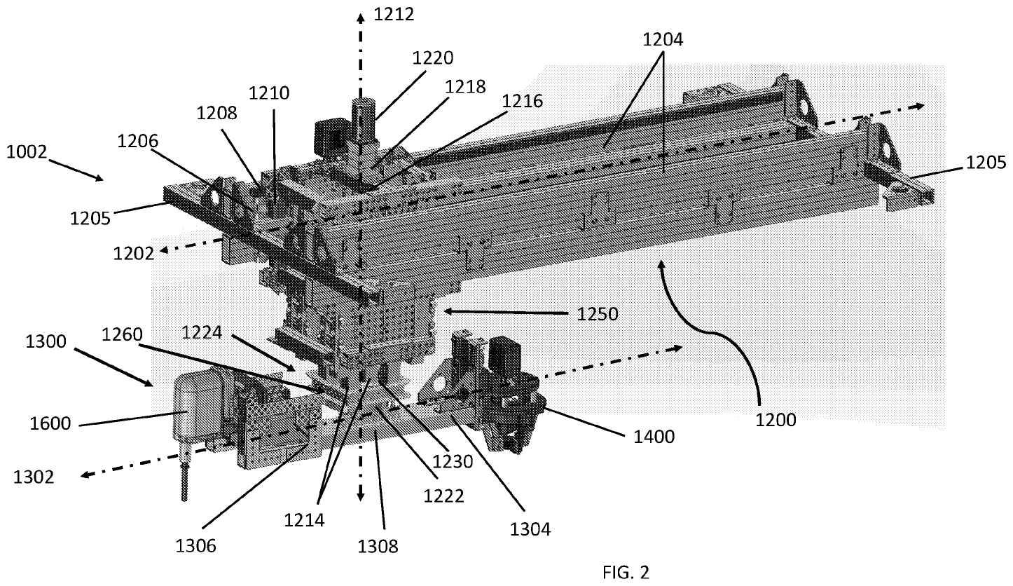

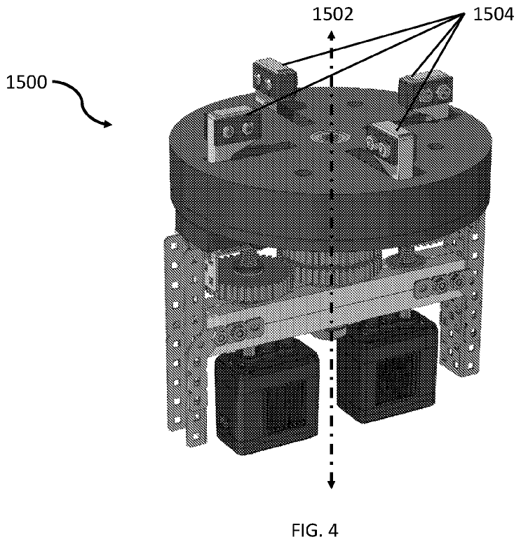

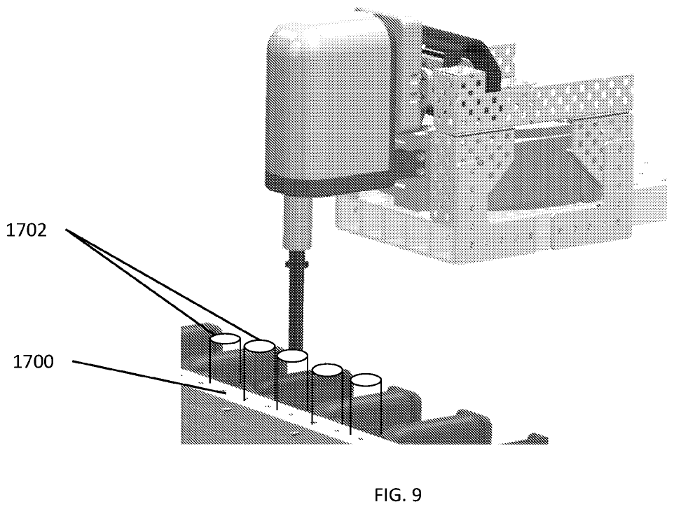

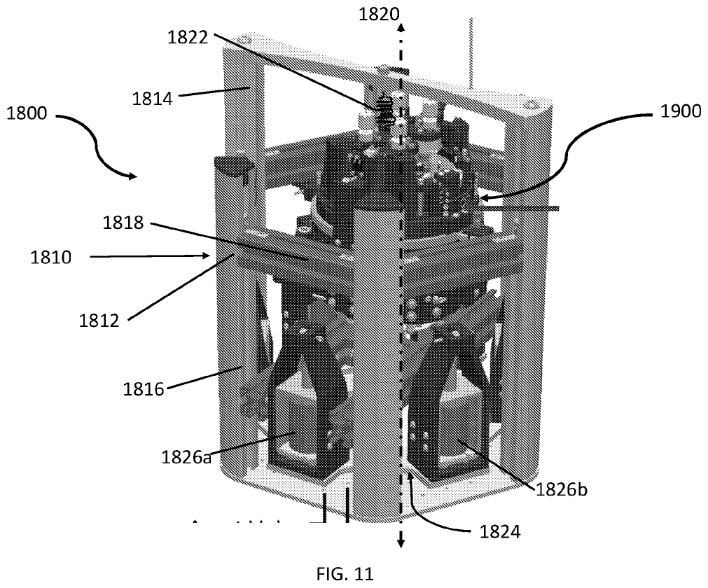

FIG. 1 shows a system 1000 for transferring free-flowing material and performing chemical reactions according to one implementation. As shown in FIG. 1, the system 1000 includes an enclosure 1100, which houses a transfer device 1002 (shown in FIG. 2), an uncapping station 1500 (shown in FIG. 4), a tool magazine 1700 (shown in FIG. 9), and a reactor 1800 (shown in FIG. 11).

In the illustrated implementation of FIG. 1, the enclosure 1100 includes four walls 1102 and two doors 1104, which define an interior volume. The enclosure 1100 further includes four casters 1106 disposed on a bottom portion of the enclosure 1100. The enclosure's interior volume includes a work surface 1108 defining a surface plane 1110. The enclosure 1100 further includes a control board 1112 configured to operate the system 1000.

Although FIG. 1 shows transparent walls 1102, in some implementations, the walls 1102 may be constructed from any material suitable for enclosing (partially or entirely) the features of the system 1000. Although FIG. 1 shows four walls 1102, two doors 1104, and four casters 1106, in some implementations, other numbers of walls 1102, doors 1104, and casters 1106 may be included.

In some implementations, the enclosure 1100 is configured to be hermetically sealed when the doors 1104 are closed. In such implementations, sealed chemical containers can be placed in the enclosure 1100 (e.g., with the manufacturer's seal attached to the chemical container), the enclosure's doors 1104 may be closed, and the sealed enclosure 1100 can be filled (or flushed) with an inert gas (e.g., purified argon gas). Accordingly, the first instance of opening the chemical container may occur within the sealed enclosure 1100. In some implementations, the enclosure includes a gas sensor and/or a humidity sensor to detect the composition of gases within the enclosure 1100 (e.g., to detect leaks) and a humidity sensor to detect moisture. In some implementations, the doors 1104 include a locking mechanism configured to lock the doors 1104 in a closed position (e.g., to limit human access to the interior of the enclosure 1100 during use).

As shown in FIG. 1, a transfer device 1002 is disposed in the interior volume of the enclosure 1100 (e.g., within the bounds of the walls 1102). FIG. 2 shows the transfer device 1002 according to one implementation.

In the illustrated implementation of FIG. 2, the transfer device 1002 comprises a gantry 1200, an arm 1300, a gripper 1400, and a tool head 1600. The gantry 1200 includes a movable positioning member 1250, which is configured for lateral movement along an x-axis 1202 (e.g., parallel to the surface plane 1110). The gantry 1200 further includes horizontal rails 1204, which are oriented along the x-axis 1202 to facilitate movement of the positioning member 1250 along the x-axis 1202. As shown in FIG. 2, distal ends of the horizontal rails 1204 are secured to support members 1205. In the illustrated embodiment, the support members 1205 are oriented perpendicular to the horizontal rails 1204 (e.g., along a y-axis relative to the x-axis 1202). A first set of linear bearings 1206 (of the positioning member 1250) are slidably engaged with the horizontal rails 1204. The gantry 1200 further includes a rack and pinion mechanism 1208 configured for driving the positioning member 1250 along the rails 1204 (e.g., along the x-axis). In the illustrated implementation, a servo motor 1210 drives the rack and pinion mechanism 1208.

As shown in FIG. 2, the positioning member 1250 defines a vertical z-axis 1212 (e.g., perpendicular to the surface plane 1110). The positioning member 1250 includes a vertical adjustment device 1260, which is oriented along the z-axis 1212. The vertical adjustment device 1260 includes several vertical rails 1214 disposed along the z-axis 1212. A second set of linear bearings 1216 are slidably engaged with the vertical rails 1214. A worm gear mechanism 1218 drives the vertical adjustment device 1260 along the z-axis 1212. In the illustrated implementation, a servo motor 1220 drives the worm gear mechanism 1218. A rotational engagement mechanism 1222 is disposed on a bottom portion 1224 of the positioning member 1250. The rotational engagement mechanism 1222 is rotatably connected to the vertical adjustment device 1260 such that it rotates about the z-axis 1212. In the illustrated implementation, a servo motor 1230 drives the rotational engagement mechanism 1222 (e.g., such that the rotational engagement mechanism 1222 rotates about the z-axis 1212).

In the illustrated implementation, the positioning member 1250 and arm 1300 (including the gripper 1400, and a tool head 1600) are suspended by the horizontal rails 1204 above the work surface 1108 (e.g., such that the arm 1300 sits above and is spaced apart from the work surface 1108). The positioning member 1250 is engaged with horizontal rails 1204 such that the positioning member 1250 is laterally movable along the x-axis 1202, while the vertical adjustment device 1260 is engaged with vertical rails 1214 so that vertical adjustment device 1260 is vertically movable along the z-axis 1212.

Although FIG. 2 shows the horizontal rails 1204 such that positioning member 1250 can move along the x-axis 1202, in some implementations the positioning member 1250 is further configured for movement along a y-axis direction (e.g., in a direction perpendicular to each of the x-axis and z-axis). For example, in certain implementations, the horizontal rails 1204 are slidably connected to the support members 1205 such that the positioning member 1250 is configured for being driven along a y-axis direction (e.g., by a servo motor driving a rack and pinion device).

FIG. 2 also shows an arm 1300, according to one implementation. The arm 1300 defines an arm longitudinal axis 1302, a first arm portion 1304, a second arm portion 1306, and a middle arm portion 1308. The second arm portion 1306 is spaced apart from the first arm portion 1304 along the arm longitudinal axis 1302. The middle arm portion 1308 is disposed between the first arm portion 1304 and the second arm portion 1306. The middle arm portion 1308 is rotatably coupled to the positioning member 1250 via the rotational engagement mechanism 1222 such that the arm longitudinal axis 1302 is perpendicular to the z-axis 1212.

FIG. 2 also shows a gripper 1400 and tool head 1600, according to one implementation. Both the gripper 1400 and tool head 1600 are coupled to the arm 1300 such that the entire arm 1300 can rotate above the work surface 1108 (e.g., about the z-axis 1212). Via lateral movement of the positioning member 1250 (e.g., along the x-axis 1202), vertical movement of the vertical adjustment device 1260 (e.g., along the z-axis 1212), and rotational movement of the rotational engagement mechanism 1222 (e.g., about the z-axis 1212), the gripper 1400 and tool head 1600 can each be moved to a desired position within the enclosure 1100.

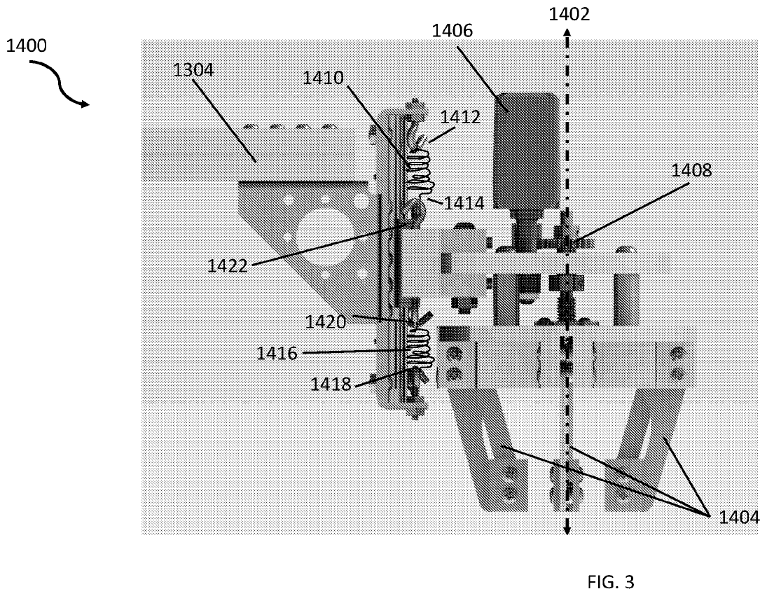

FIG. 3 shows a profile view of the gripper 1400, according to one implementation. The gripper 1400 is configured to open and close containers disposed on the work surface 1108 within the enclosure 1100. In the illustrated implementation, the gripper 1400 is movably coupled to the first arm portion 1304 such that the first arm portion 1304 serves as a base for the gripper 1400. The gripper 1400 defines a gripper axis 1402, four fingers 1404, a gripper actuator 1406, a worm gear 1408, a first gripper spring 1410, a second gripper spring 1416, and a gripper bearing 1422.

The four fingers 1404 are radially movable relative to the gripper axis 1402 between a first position and a second position, such that the fingers 1404 are closer to the gripper axis 1402 in the second position than in the first position. The gripper actuator 1406 causes the fingers 1404 to move radially (inward or outward) relative to the gripper axis by causing a worm gear 1408 to engage with a flange nut and vertical displacement device to move the fingers 1404 between the first position and the second position.

The gripper 1400 is configured to accurately remove and attach chemical container lids. In the illustrated implementation, the gripper 1400 includes the first gripper spring 1410 and second gripper spring 1416. First gripper spring 1410 has a first spring end 1412 and a second spring end 1414. The first spring end 1412 is statically coupled to the first arm portion 1304 and the second spring end 1414 is statically coupled to the gripper 1400.

Second gripper spring 1416 has a first spring end 1418 and a second spring end 1420. The first spring end 1418 is statically coupled to the first arm portion 1304 and the second spring end 1420 is statically coupled to the gripper 1400. The first gripper spring 1410 and second gripper spring 1416 are biased in opposite directions. The opposite bias of the springs 1410, 1416 allows a lid to move up or down along the gripper axis 1402 as it is opened or closed.

The gripper 1400 is movably coupled to the first arm portion 1304 such that gripper bearing 1422 is slidably engaged with the first arm portion 1304. The gripper 1400 can thus move in a direction along the gripper axis 1402. Although FIG. 3 shows a gripper 1400 which can slide along the gripper axis 1402, in some implementations, the gripper 1400 can also be configured to rotate about the gripper axis 1402 (e.g., driven by an actuator rotating the gripper 1400 about the axis 1402).

In some implementations, the gripper 1400 and gripper springs 1410 and 1416 may be pre-loaded or pre-tensioned in a direction to facilitate removal or placement of a chemical container's lid. A pre-loading operation may be accomplished, for example, by the following steps: i) the gripper fingers 1404 engage with the lid, ii) the positioning member 1250 translates in the z-direction by some distance smaller than the height of the lid, iii) one or both of the gripper 1400 and uncapping station 1500 rotate in order to remove or place the lid, and iv) the gripper 1400 translates on the first arm portion 1304 and the gripper bearing in the z-direction as the lid moves up or down along the lid threads. In some implementations, the direction of translation of the positioning member 1250, and resultant bias of the gripper springs 1410, 1416, may be altered depending on the size of lid and operation performed (removal or placement of the lid). In some implementations, a gripper actuator attached to the gripper 1400 is configured pre-load or pre-tension the springs by moving the gripper along the gripper bearing to load the springs.

Although FIG. 3 shows four fingers 1404, in some implementations the gripper 1400 may include as few as two fingers 1404. In some implementations, the gripper 1404 may include three fingers 1404 or more than four fingers 1404, for example, five, six, or eight fingers 1404.

FIG. 4 shows an uncapping station 1500, according to one implementation. The uncapping station 1500 works with the gripper 1400 to remove or place a lid on a chemical container. The uncapping station 1500 is disposed on the work surface 1108 such that a chemical container may be placed within the uncapping station 1500 for removing or attaching a lid. The uncapping station 1500 defines an uncapping axis 1502 and four uncapping fingers 1504. The uncapping fingers 1504 are radially movable relative to the uncapping axis 1502 between a first position and a second position such that the uncapping fingers 1504 are closer to the uncapping axis 1502 in the second position that in the first position. The uncapping fingers 1504 are rotatable about the uncapping axis. Thus, the gripper 1400 is configured for grabbing a lid of a chemical container while the uncapping station 1500 rotates the chemical container. In some implementations, either one of the gripper 1400 or uncapping station 1500 (or both) can be configured to rotate.

In some implementations, a chemical container remains sealed when placed inside a hermetically sealed enclosure (e.g., the container retains the manufacturer's seal). In some implementations, the first time a container's seal is broken occurs within the enclosure, separate from human contact or exposure to atmospheric oxygen or moisture. The potentially hazardous chemicals are thus quarantined to the enclosure for the duration of an experiment, while a human may remain separate and outside the enclosure for the duration of the experiment.

In some implementations, a wide range of chemical container shapes and sizes may be opened and closed with the gripper and uncapping station. For example, the movable fingers of the gripper 1400 and uncapping station 1500 allow for containers of various depths, heights, radii, circumference, and overall shape to be opened and closed. Thus, in some implementations, the gripper 1400 and uncapping station 1500 are configured to adapt to a given chemical container's shape.

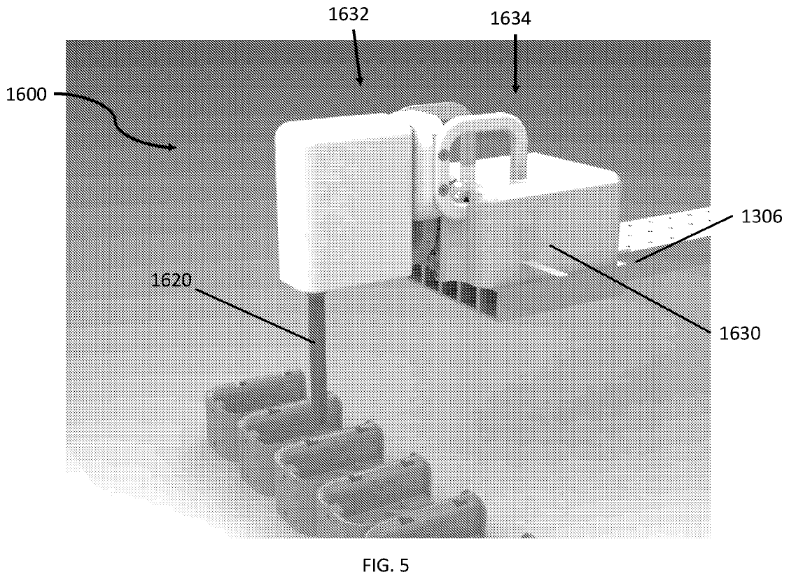

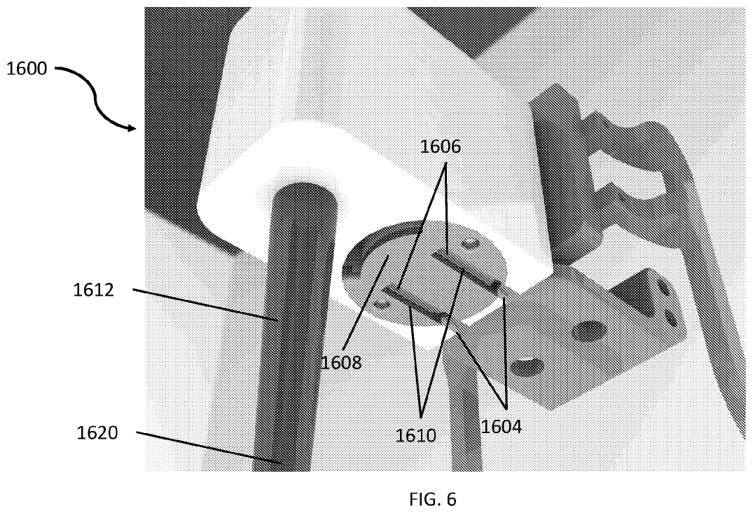

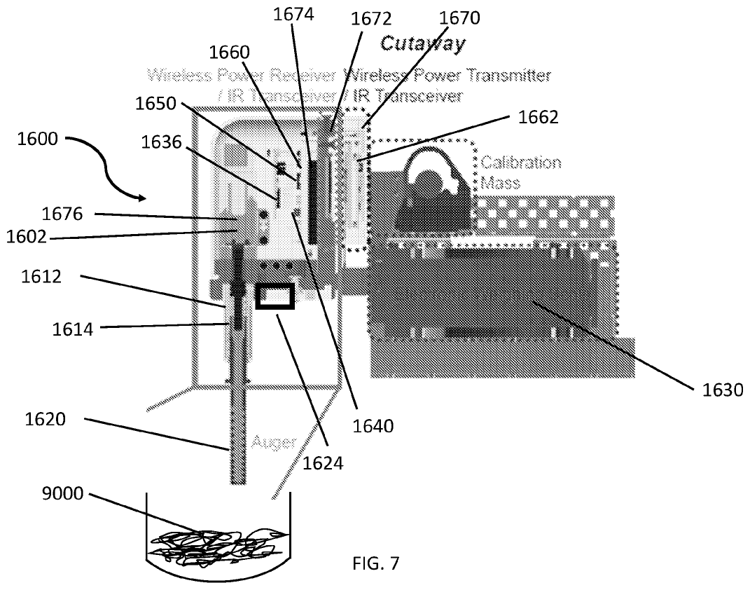

On the opposite side of the arm 1300 from the gripper 1400 is a tool head 1600. The tool head 1600 is configured to handle material location within chemical containers or elsewhere in the enclosure 1100. FIGS. 5-7 show a tool head 1600, according to one implementation. The tool head 1600 is removably coupled to the second arm portion 1306, such that the second arm portion 1306 serves as a base for the tool head 1600. The tool head 1600 includes a tool head motor 1602 (shown in FIG. 7), head coupling openings 1604, head coupling protrusions 1606, rotatable locking plate 1608, a tool coupling portion 1612 (shown in FIG. 6), a tool 1620, a weighing scale 1630, a processor 1640, a memory 1650, and a first wireless power transmission coil 1670 (shown in FIG. 7).

The tool head 1600 shown in FIGS. 5 and 6 includes two head coupling openings 1604 and two head coupling protrusions 1606 coupled to the second arm portion 1306. The head coupling protrusions 1606 are configured to be disposed within each of the head coupling openings 1604 on a first side of the tool head to removably couple the tool head 1600 to the second arm portion 1306. The rotatable locking plate 1608 defines two plate openings 1610 sized to receive the head coupling protrusions 1606. Within the tool head 1600, adjacent to the rotatably locking plate 1608, is a guide element that is slidable by a ramp. The guide element and ramp engage with head coupling protrusions 1606 to move the locking plate 1608 between the locked position and unlocked position.

The rotatable locking plate 1608 is rotatable from a locked position to an unlocked position such that the head coupling protrusions 1606 are blocked from moving through, into, or out of the plate openings 1610. Thus, tool head 1600 may be swapped out for another tool head 1600 depending on the activity required at the time.

The tool coupling portion 1612 is couplable to a tool 1620. The tool coupling portion 1612 includes a cam and thruster mechanism 1614 for coupling the tool coupling portion 1612 to the tool 1620. The tool 1620 is an auger configured to pick up free-flowing material 9000. The tool head motor 1602 drives the auger to rotate about an auger longitudinal axis 1622. Further, a shaker 1676 is coupled to the tool head 1600 for causing vibrations in the tool 1620.

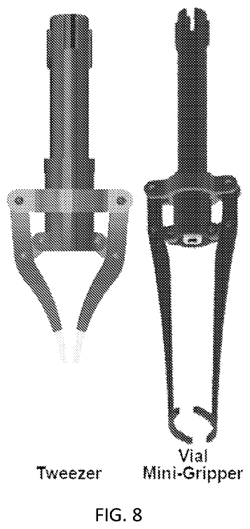

Although FIGS. 5-7 show an auger, in some implementations, the tool 1620 is any other solid material handling tool, for example a tweezer or a vial mini-gripper, where the tool head motor 1602 would drive the tips of tweezer or vial mini-gripper together or apart from each other. Examples of alternative implementations of tools, including a tweezer tool and vial gripper, are shown in FIG. 8.

In various implementations, the tool 1620 may be a liquid material handling tool. Although FIGS. 5-7 show an auger, in some implementations, the tool 1620 is any other liquid material handling tool, for example a liquid pipetting module. In some implementations, the tool head 1600 is a liquid material handling tool, for example, a liquid pipetting module. In various implementations, either one of the tool 1620 and the tool head 1600 is a liquid material handling device, including a syringe. In some implementations, the tool head and tool head motor are configured to engage with a syringe in order to push and/or pull a plunger of the syringe to draw up or push out viscous liquid.

Additionally, the tool 1620 is, in some implementations, an electrostatic pickup tool for obtaining milligram quantities of free-flowing material. An example of an electrostatic pickup tool according to various implementations may be found as described in U.S. Pat. No. 6,948,537 (“Systems and methods for collecting a particulate substance”), with reference to at least FIGS. 6-7 therein. In various implementations, the tool head 1600 is configured to make electrical contact with the tool 1620 (e.g., to engage with an electrostatic pickup tool).

In various implementations, the tool head 1600 of FIGS. 5-7 can include a different number of head coupling openings 1604 and head coupling protrusions 1606. For example, an implementation can use one or three or four different head coupling openings 1604 and head coupling protrusions 1606. Similarly, the rotatable locking plate 1608 can define a different number of plate openings 1610 in various implementations.

FIG. 5 further shows a weighing scale 1630, according to one implementation. The weighing scale 1630 includes a mass-sensitive portion 1632 coupled to the tool head 1600, a non-mass-sensitive portion 1634 coupled to the second arm portion 1306, and a current sensor 1636 for sensing current flow in the tool head motor 1602. The weighing scale 1630 and mass-sensitive portion 1632 are isolated such that weight measurements can be gathered automatically without the use or wires or other matter affecting the weighing scale 1630 on the tool head 1600.

The tool head 1600 and weighing scale 1630 further include a processor 1640 and a memory 1650, wherein the processor 1640 executes computer-readable instructions 1642 stored on the memory 1650. The instructions cause the processor 1640 to i) Receive a first mass measurement from the weighing scale 1630; ii) Energize the tool head motor 1602 to cause the tool 1620 to collect a portion of the free-flowing material 9000; iii) Receive sensor data from the current sensor 1636; iv) De-energize the tool head motor 1602; v) Determine the amount of time the tool head motor 1602 was energized or the number of motor rotations; vi) Receive a second mass measurement form the weighing scale 1630; vi) Determine a flow consistency property of the free-flowing material 9000 based on the amount of time the tool head motor 1602 was energized or the number of motor rotations, the difference between the first mass measurement and the second mass measurement, and the sensor data from the current sensor 1636.

Although the processor 1640 of FIGS. 5-7 executes instructions 1642 as described above, in some implementations, the processor 1640 executes different instructions 1642 as elsewhere described, for example, by calculating collection rates of free-flowing material.

In various implementations, the system 1000 includes a first infrared communication system 1660 in electrical communication with the processor 1640 and coupled to and in electrical communication with the tool head motor 1602. In various implementations the system 1000 includes a second infrared communication system 1662 coupled to and in electrical communication with the tool head motor 1602. In some implementations, the first infrared communication system 1660 and the second infrared communication system 1662 include a transmitter and a receiver.

FIG. 7 further includes a first wireless power transmission coil (WPT) 1670 coupled to the second arm portion 1306, according to one implementation. A second WPT coil 1672 is coupled to the tool head 1600 wherein the first WPT coil 1690 is spaced apart from the second WPT coil 1672. The first WPT coil 1670 is energizable and causes current to flow through the second WPT coil 1672. Further, a battery 1674 is in electrical communication with the second WPT coil 1672 such that the battery 1674 is charged.

In various implementations, the tool head 1600 of FIGS. 5-7 can include a range sensor 1624 coupled to the tool head 1600 or to the second arm portion 1306. The range sensor 1624, which may be a time-of-flight sensor, determines the distance from the free-flowing material 9000 to the range sensor 1624. In various implementations, the range sensor 1624 may be configured to relay distance information to the processor 1640. In various implementations, the processor 1640 may cause the movable positioning member 1250 to move in the z-direction depending on the distance between the tool 1620 and the free-flowing material 9000.

While the tool (e.g., an auger), gathers material from a chemical container, material is removed from the space immediately around the tip of the tool 1620. In various implementations, the positioning member 1250 moves the tool 1620 (e.g., an auger) lower into free-flowing material 9000 in order to gather a consistent density of free-flowing material 9000. In various implementations, the tool is lowered into the free-flowing material such that the tool pushes up on a spring which acts like a shock absorber (see discussion of the cam and thruster mechanism below). The shock absorbing action of a portion of the tool and tool head creates a constant pressure on the tool such that a constant density of material may be gathered. A constant material density within an auger, for example, ensures more accurate measurements with respect to the weighing scale and timing operations performed by the processer, such that weighing accuracy of the system is improved.

In various implementations, a tool may gather free-flowing material from one chemical container in multiple iterations. Inconsistent free-flowing material height may result. In various implementations, the processor is configured to perform instructions such that the gripper moves a chemical container onto the uncapping station after a set number of material gathering operations. In some implementations, the uncapping station may spin or shake the chemical container at an angular velocity and/or angular acceleration sufficient to remove inconsistencies in the free-flowing material (e.g., smoothing out the powder surface within a chemical container).

As described above, tools 1620 may be exchanged based on the current activity or need. FIG. 9 shows a tool magazine 1700, according to one implementation. The tool magazine 1700 includes an array of slots 1702 to receive and hold the tools 1620 when not coupled to the tool coupling portion 1612 of the tool head 1600. The tool head 1600 moves towards the tool head magazine 1700 to connect and/or disconnect a tool 1620 from the tool coupling portion 1612 via the cam and thruster mechanism 1614 present within each tool 1620 and each slot 1702.

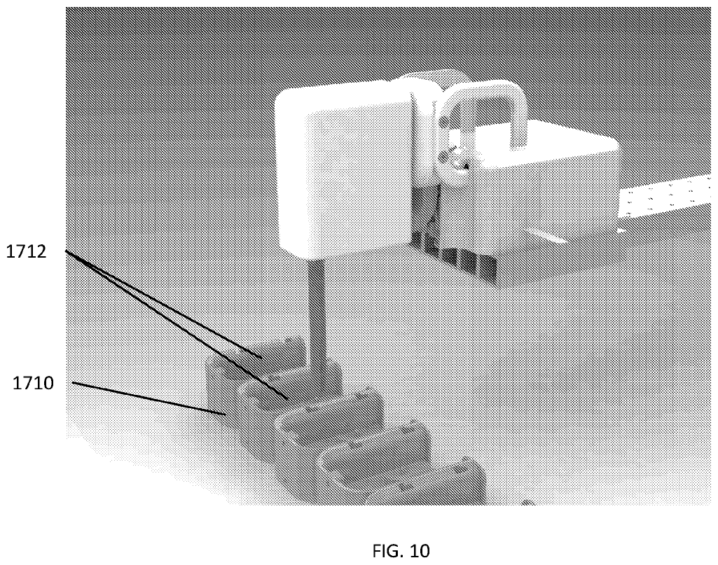

As described above, tool heads 1600 may be exchanged based on the current activity or need. FIG. 10 shows a tool head tray 1710, according to one implementation. The tool head tray 1710 includes an array of stations 1712 to receive and hold the tool heads 1600 when not coupled to the second arm portion 1306 via the head coupling openings 1604. The second arm portion 1306 moves towards the tool head tray 1710 to connect and/or disconnect a tool head 1600 from the second arm portion 1306 via the head coupling openings 1604 and head coupling protrusions 1606.

Disposed on the work surface 1108 is a reactor system 1800. The tool head 1600 is configured to deposit and/or remove material from the reactor system 1800 for performing chemical reactions. The tool head 1600 thus moves around and above the reactor system 1800 within the enclosure 1100, while the reactor system 1800 remains stationary on the work surface 1108.

FIG. 11 shows a reactor system 1800, according to one implementation. The reactor system 1800 includes an outer support structure 1810 and a reactor core 1900. The outer support structure 1810 includes a frame 1812 having a first frame portion 1814 and a second frame portion 1816 spaced apart from the first frame portion 1814. The outer support structure 1810 further includes a side frame portion 1818 extending from the first frame portion 1814 to the second frame portion 1816. A frame longitudinal axis 1820 extends from the first frame portion 1814 to the second frame portion 1816.

Two resilient members are attached to the reactor core 1900 such that the entire reactor core 1900 can be translated, shook, rotated, or tilted at a point during the chemical reaction, effectively providing mechanical force to the chemical reaction. As shown in FIG. 11, a spring 1822 extends from the first frame portion 1814 to a first core side 1902 (thereby functioning as a first resilient member). As shown in FIG. 11, a spring 1824 extends from the second frame portion 1816 to a second core side 1904 (thereby functioning as a second resilient member) such that the reactor core 1900 is disposed between the first frame portion 1814 to the second frame portion 1816 and is suspended by the first resilient member 1822 and the second resilient member 1824.

The reactor system 1800 of FIG. 11 further includes six actuators 1826 extending from the frame 1812 to the reactor core 1900. Each actuator 1826 is movable from an extended position to a retracted position to cause the reactor core 1900 to move radially relative to the frame longitudinal axis.

The reactor system 1800 of FIG. 11 further includes a processor in electrical communication with the actuators 1826 and a memory. The processor executes computer-readable instructions stored on the memory.

These instructions cause the processor send signals each of the actuators 1826a, 1826b, and others not pictured. Signals are sent in rapid succession in order to create a movement or the reactor core via the actuators 1826. In FIG. 11, the net result of these instructions and actions is that the reactor core is moved in a circular manner about a central axis.

Although the reactor system 1800 of FIG. 11 includes six actuators 1826, in other implementations there are fewer actuators, for example one or two actuators configured to shake the reactor core 1900 back and forth. In other implementations, there are three or four actuators configured to move the reactor core 1900 radially relative to the frame longitudinal axis 1820. In other implementations, there are five or seven or eight actuators. In some implementations, a cable coupling is included to connect the actuator to the outer support structure 1810.

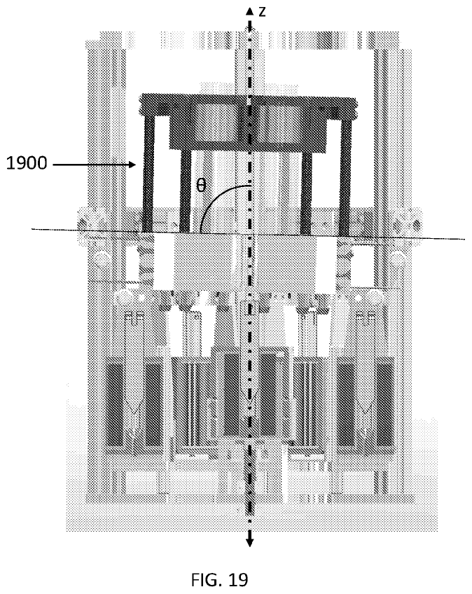

Although the actuators 1826 shown in FIG. 11 are configured to shake the reactor core 1900 in the x-y plane, in some implementations, the reactor core may shake in the x-, y-, and z-direction. An example implementation is shown in FIG. 19 where reactor core 1900 may be tilted at a variable angle θ with respect to the z-axis. In various implementations, the second resilient member (or “lower spring”) member may be removed so that the reactor core may tilt at an angle to the z-axis, as shown in FIG. 19. The variation including the lower spring may be referred to as the “shake mode,” while the variation without the lower spring engaged may be referred to as “centrifuge mode.” In some implementations, the lower spring may be tightened or loosened (engaged or disengaged) automatically to switch between shake mode or centrifuge mode (e.g., by means of a solenoid on the bottom of the outer support structure.

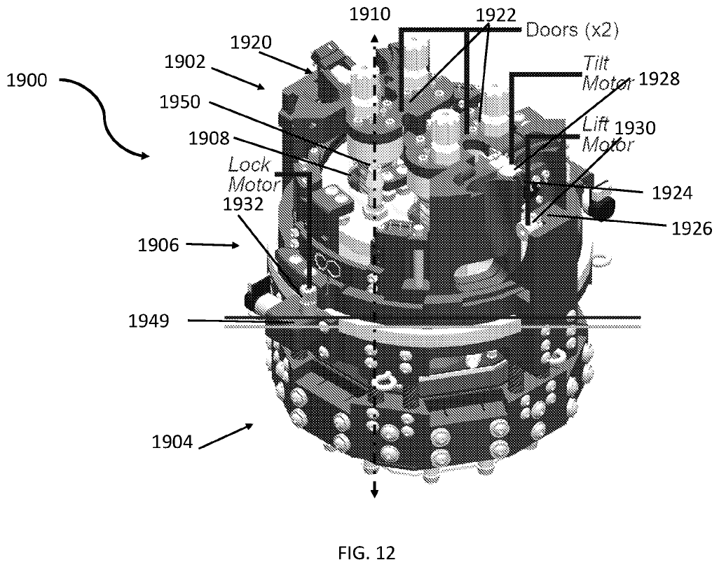

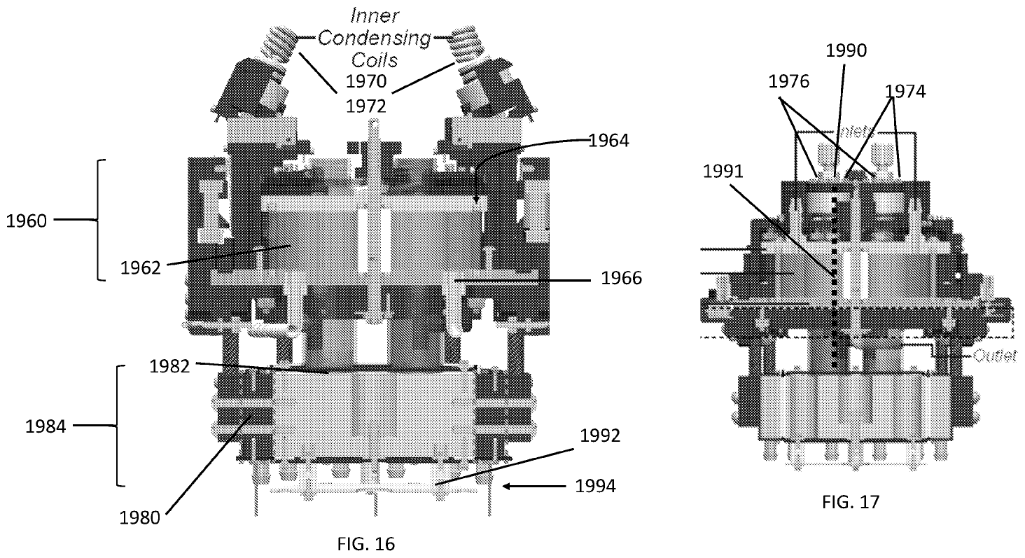

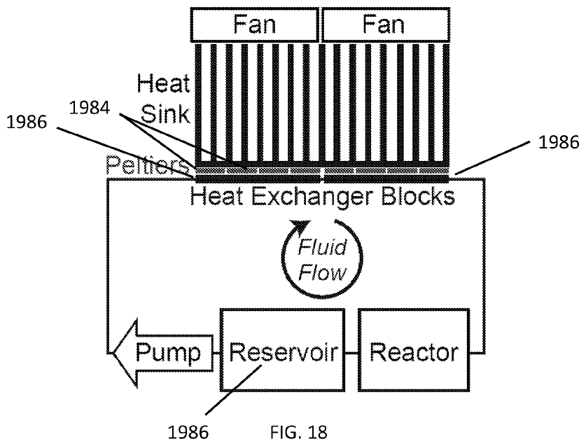

The reactor core 1900 includes a first core side 1902, a second core side 1904, a body 1906, a container opening 1908, a door system 1920 (shown in FIG. 12), an outer condenser 1960, an inner condenser 1970, a thermoelectric unit 1980 (shown in FIGS. 16-18), and a laser device 1990. The reactor core 1900, according to one implementation, is configured to receive four containers for containing a chemical reaction 1950, or simply, “containers” 1950. The body 1906 defines a container opening 1908 for receiving the containers 1950. The container opening 1908 defines a container longitudinal axis 1910.

The door system 1920 effectively covers and seals each of the containers 1950 so that chemical reactions may be performed, controlled, and analyzed. The door system 1920 of FIGS. 12-17 includes a door 1922 for sealingly abutting a lip 1952 of an opening 1954 defined by the container 1950 disposed within the container opening 1908. The door system 1920 further includes a door hinge 1924 coupled to the door 1922 and a door lift 1926 coupled to the door hinge 1924 such that the door 1922 is hingable by the door hinge 1924 relative to the door lift 1926. The door lift 1926 is configured to move the door 1922 along the container longitudinal axis 1910 relative to the body 1906. The door system 1920 further includes a door hinge motor 1928 for causing the door hinge 1924 to hinge the door 1922 relative to the door lift 1926. A door lift motor 1930 causes the door lift 1926 to move the door 1922 along the container longitudinal axis 1910 relative to the body 1906. A rack and pinion mechanism 1932 is coupled to the body 1906 and coupled to the door lift 1926.

The door system 1920 of FIGS. 11-17 further includes a door lock 1934 including a lock protrusion 1936 movable from a locked to an unlocked position. The lock protrusion 1936 is engaged with a lock opening 1938 defined by the door 1922 to prevent hinging or movement of the door 1922 in the locked position, as seen in FIGS. 11-14. The lock protrusion 1936 is disengaged with the lock opening 1938 in the unlocked position.

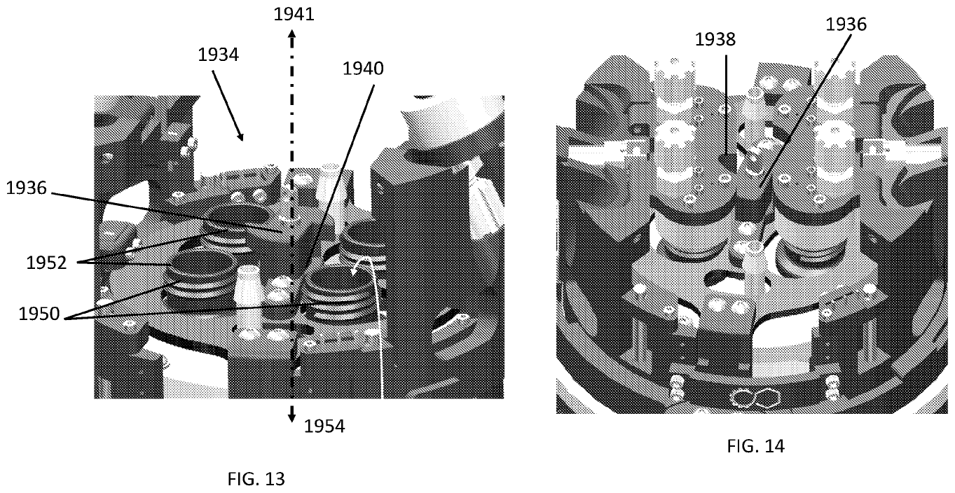

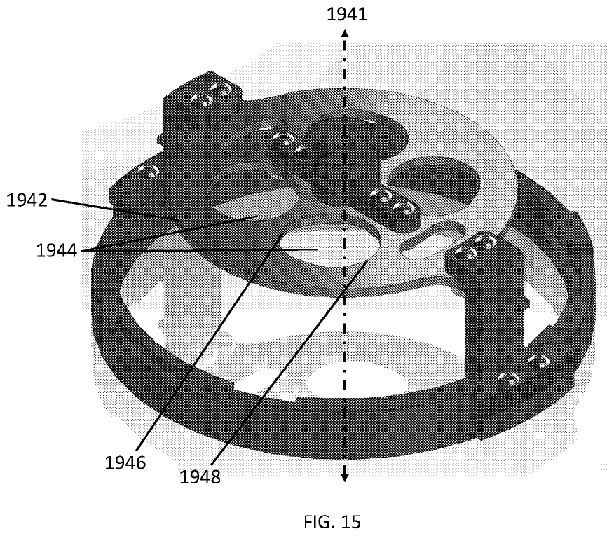

The door lock 1934 further includes a lock shaft 1940 having a lock longitudinal axis 1941. The lock protrusion 1936 extends radially from the lock shaft 1940 relative to the lock longitudinal axis 1941, as seen in FIG. 13. The movement of the lock protrusion 1936 is circumferential rotation relative to the lock longitudinal axis 1941. A lock plate 1942 defines a container lock opening 1944 aligned with the container opening 1908, as seen in FIG. 15. The container lock opening 1944 includes a retaining portion 1946 and a releasing portion 1948. The retaining portion 1946 has a narrowest width that is narrower than a widest diameter of the container 1950 and the releasing portion 1946 has a narrowest width that is wider than the widest diameter of the container 1950. The retaining portion 1946 of the container lock opening 1944 is aligned with the container opening 1908 in the unlocked position and the releasing portion 1948 of the container lock opening 1944 is aligned with the container opening 1908 in the locked position. A lock motor 1949 moves the lock protrusion 1936 from the locked to the unlocked position. In some implementations, the lock plate 1942 with retaining portion 1946 holds the containers in place while the door system (or other container lid or cover) is removed.

The door lock 1934 further includes a lift lock 1949 engageable with the door lift 1926. In the locked position the lift lock 1949 is engaged with the door lift 1926 to prevent movement of the door 1922 along the container longitudinal axis 1910 relative to the body 1906. In the unlocked position the lift lock 1949 is disengaged with the door lift 1926.

The reactor core 1900 can also control the temperature of a chemical reaction in the container 1950. In FIGS. 16-17, the reactor core 1900 further includes an outer condenser 1960, according to one implementation. The outer condenser 1960 includes a condensing fluid reservoir 1962 in thermal contact with a container 1950 when the container is disposed in the container opening 1908. The outer condenser 1960 further includes an outer condenser inlet 1964 in fluid communication with the condensing fluid reservoir 1962 and an outer condenser outlet 1966 in fluid communication with the condensing fluid reservoir 1962.

In FIGS. 16-17, the reactor core 1900 further includes an inner condenser 1970, according to one implementation. The inner condenser 1970 includes a condenser coil 1972 coupled to the door 1922 such that the condenser coil 1972 is disposed within the container 1950 when the door 1922 is sealingly abutting the lip 1952 of the opening 1954 defined by the container 1950 when the container 1950 is disposed within the container opening 1908. An inner condenser inlet 1974 is in fluid communication with the condensing fluid reservoir 1962, and an inner condenser outlet 1976 is in fluid communication with the condensing fluid reservoir 1962.

In FIGS. 16-18, the reactor core 1900 includes thermoelectric units 1980, according to one implementation. Thermoelectric units 1980 are in thermal contact with the container 1950 when the container 1950 is disposed within the container opening 1908. Further, a temperature sensor 1982 is in thermal contact with the thermoelectric unit 1980. The reactor core 1900 further includes a heat exchanger 1984 including a heat exchange fluid reservoir 1986 in thermal contact with the thermoelectric unit 1980. A heat exchange inlet 1988 and heat exchange outlet 1989 are both in fluid communication with the heat exchange fluid reservoir.

Although the thermoelectric unit 1980 in FIGS. 16-18 is a Peltier device, in some implementations, the thermoelectric unit is a resistive heater or any other heating device.

The reactor core 1900 of FIGS. 16-17 includes a laser device 1990, according to one implementation. The laser device 1990 emits a laser 1991 through a portion of the container 1950 when the container 1950 is disposed within the container opening 1908. A photodetector 1992 is positioned to receive the emitted laser 1991. A photo-optic circuit board 1994 emits light into the container 1950 when the container is disposed within the container opening 1908. The photo-optic circuit board 1994 can emit a range of wavelengths of light into the container 1950. In various implementations, multiple lasers 1991 and photodetectors 1992 are included corresponding to each container 1950. For example, two or three or four or five or eight or ten containers 1950 may be included. For example, two or three or four or five or eight or ten lasers 1991 and photodetectors 1992 may be included in as many or fewer containers 1950

Although the reactor core 1900 includes four containers 1950, in other implementations there are other numbers of containers. For example, a single container, two containers, three containers, five containers, ten containers, or twenty containers may be disposed within a corresponding number of container openings within the reactor core. Additionally, a corresponding number of doors may match the different number of containers in various implementations.

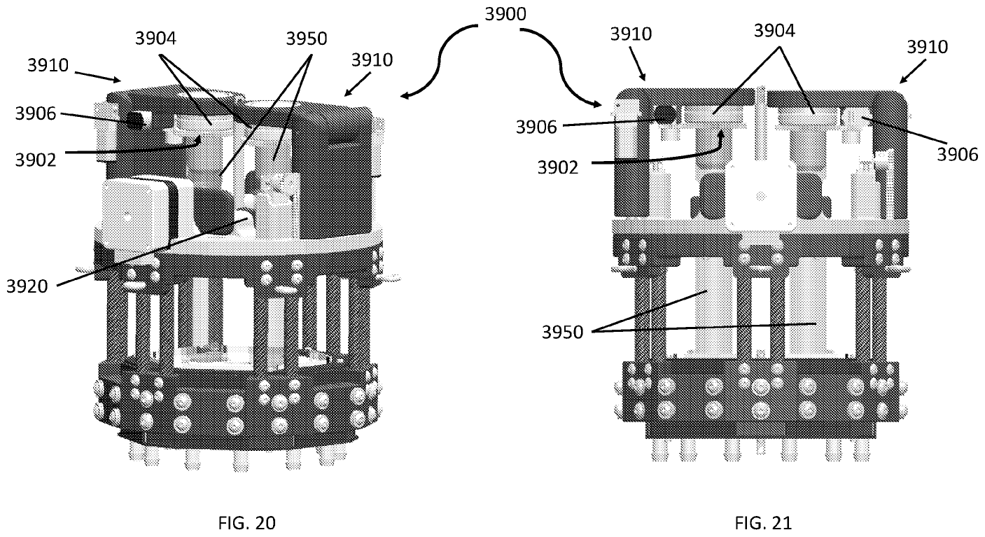

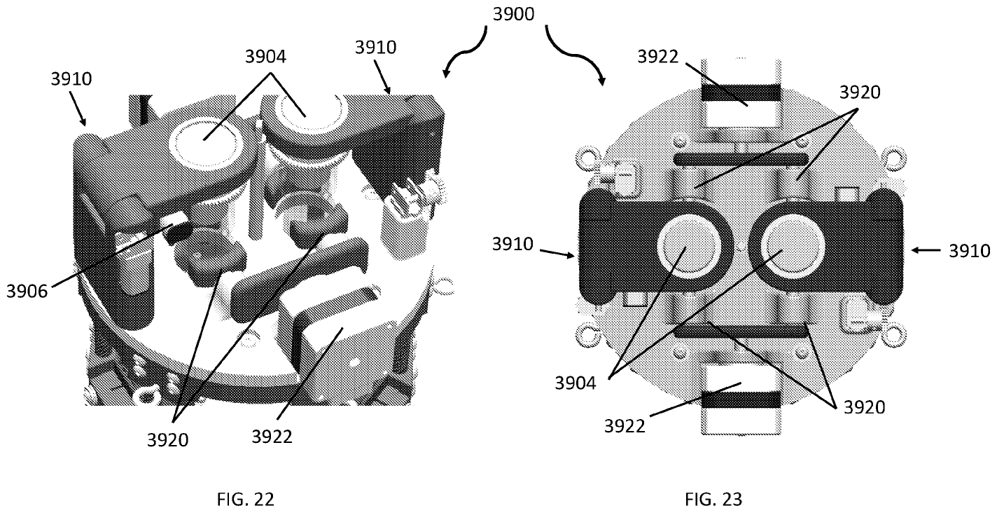

In various implementations, a high-pressure reactor core 3900 may be provided, as shown in FIGS. 20-23. Such a configuration would be used in high pressure reactions and/or reactions in the gas phase. Although the containers 1950 of FIGS. 12-17 are shown with a lip 1952, in some implementations with a high-pressure reactor core 3900, the containers 3950 also include threads 3902 configured to receive a threaded top sealing member 3904, as shown in FIGS. 20-23. In a high-pressure reactor core 3900, according to some implementations, the door system is replaced with a high-pressure door mechanism 3910, as shown in FIGS. 20-23. The high-pressure door mechanism 3910 is capable actuating and twisting top sealing members 3904 onto the containers 3950 such that the threads 3902 of the containers 3950) receive the top sealing members 3904. Actuator motors 3906 are disposed adjacent to the top sealing members 3904 to drive the twisting action. In some implementations, the containers 3950 are held stationary by stationary arms 3920 disposed on the side of the containers 3950. The stationary arms are driven by arm motors 3922.

### Example Description of One Implementation: Cam and Thruster Mechanism

The tool head 1600 shown in FIGS. 5-7 includes the tool coupling portion 1612 which further includes a cam and thruster mechanism 1614 for coupling the tool coupling portion 1612 to the tool 1620. The cam and thruster mechanism will be described here in more detail in order to provide context to the connection between tool and tool coupling portion. This description is one implementation of the cam and thruster mechanism, and other implementations may be used for connecting the tool to the tool coupling portion of the tool head.

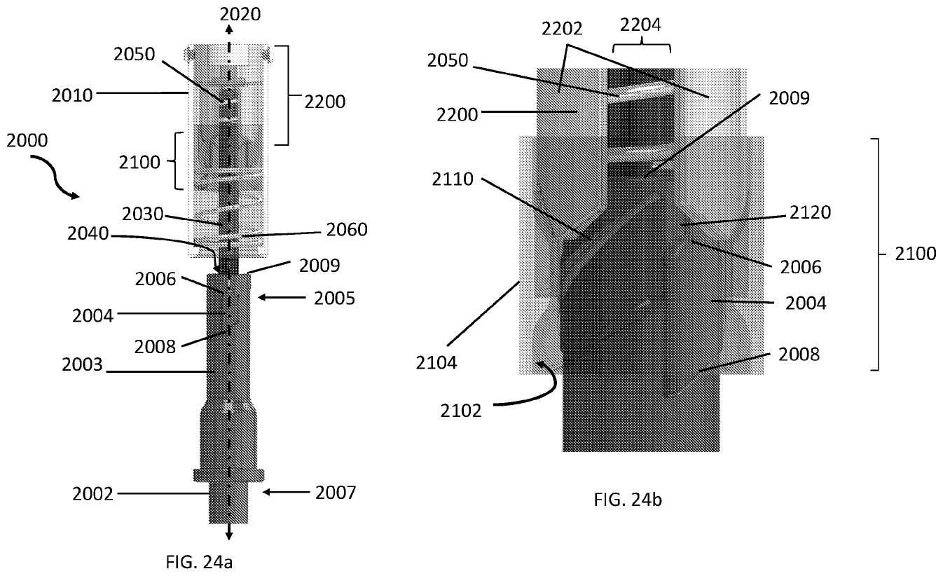

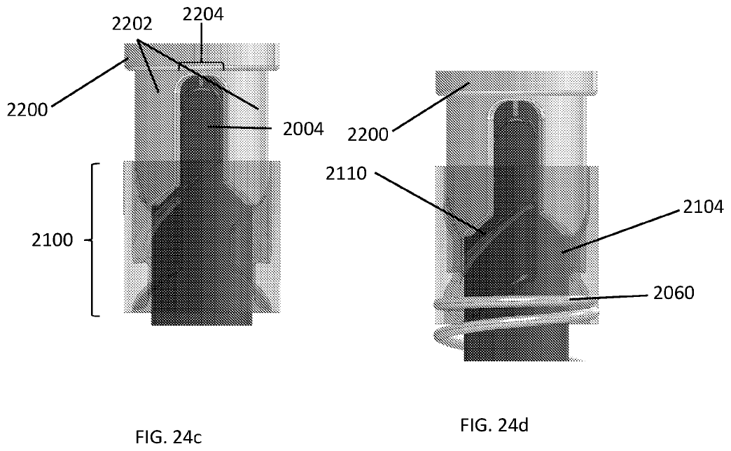

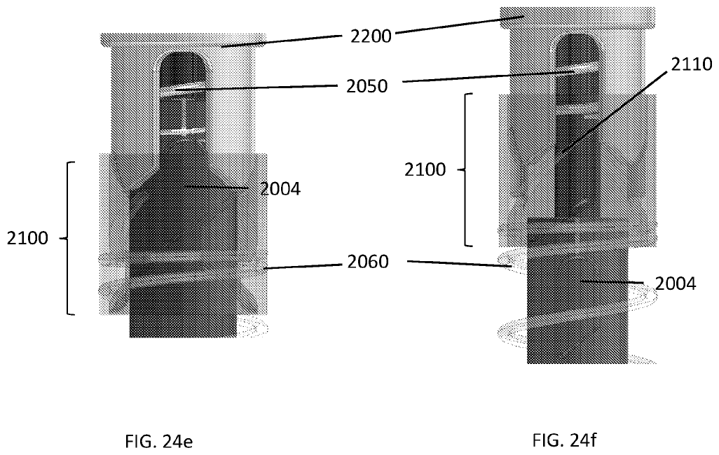

FIGS. 24a-f show a cam and thruster mechanism 2000, according to one implementation. The cam and thruster mechanism 2000 includes a tool 2002, a housing 2010, a tool axis 2020, a central axle 2030, an axle cutout 2040, an upper spring 2050, a lower spring 2060, a cam 2100, and a plunger 2200.

The tool 2002 is fixably attached to the central axle 2030. A tool axis 2020 extends from a first end 2005 to a second end 2007 of the tool 2002. The central axle 2030 and a circumferential surface 2006 of the tool 2002 are coaxial with the tool axis. The tool 2002 includes two fins 2004 disposed on a circumferential surface 2003 of the tool 2002 such that each fin 2004 is spaced apart from the other around the circumferential surface 2003. The fins include a curved surface 2006 towards the top and first end 2005 and an angled surface 2008 towards the second end 2007. The tool 2002 further includes a lip 2009 on the top end 2005.

The housing 2010 is fixably attached to the tool head 2600. The housing 2010 includes the plunger 2200 disposed within the housing 2010. The drive axle 2030 is fixably attached to the tool head 2600 such that the central axle 2030 is rotatably attached to the drive axle such that torque is transferred from the tool head motor 2602 (not pictured in FIGS. 24a-f). The upper spring 2050 is fixably attached to the plunger 2050, while the lower spring 2060 is fixably attached to the housing 2010. The upper spring 2050 has a spring coefficient greater than that of the lower spring 2060.

As seen in FIGS. 10a and 10b, the cam 2100 is coaxial to the tool axis 2020 and is disposed within the housing 2010. The cam 2100 sits around the plunger 2200 such that they are slidably and rotatably engaged. The cam 2100 includes an inner circumferential surface 2102 and an outer circumferential surface 2104. The inner circumferential surface 2102 includes ramps 2110 and slots 2120.

The plunger 2200 includes four prongs 2202 and four slots 2204. The ramps 2110 and slots 2120 of the cam 2100, as well as the fins 2004 of the tool 2002, are all configured to interact with one another in a slidable manner in order to lock the tool 2002 in place.

In use, the cam and thruster mechanism 2000 shown in FIGS. 24a-f can pick up a tool from the tool magazine by applying a downward force from the tool head. It can also release a tool by applying a similar force once the tool is back in the tool magazine. According to one implementation, the tool 2002 is inserted into the housing 2010 by movement of the tool head 2600 to align with the tool 2002. The central axle 2030 includes male connection end shaped to engage with a corresponding female connection end of the axle cutout 2040. In some implementations, the male and female connections form a plus “+” shape to engage with a corresponding plus “+” shape keyhole, axle cutout 2040. In other implementations, the male and female connections include a varied number of lobes for connection, for example three or five lobes. Thus, the central axle 2030 may slide within the axle cutout in a z-direction along tool axis 2020 while maintaining torque transfer with the tool 2002.

As the tool 2002 is pushed further into the housing, ramps 2110 on the cam 2100 orient the tool 2002 towards the prongs 2202 of the plunger 2200. The engagement is seen in FIG. 24b, as one implementation. The cam 2100 engages with prongs 2202 and revolves about the tool axis 2020. The fins 2004 slide into the slots 2204 of the plunger 2200, as seen in FIG. 24c. At the same time, the upper spring 2050 is compressed by the lip 2009. The lower spring 2060 then compresses, allowing the cam 2100 to rotate further and close the slots 2204 in the plunger 2200 so that the tool 2002 cannot fall out, as seen in FIG. 24d.

As upward pressure on the tool 2002 is removed, the greater spring coefficient of the upper spring 2050 overcomes that of the lower spring 2060, pushing the cam 2100 downwards. The internal ramps 2110 pass a critical point of the prongs 2202, sliding into a locked position, as seen in FIG. 24d. Thus, the tool 2002 is in a position to operate.

To remove, the process is repeated. Downward pressure is applied until the fins 2004 reach a critical point. The downward pressure from the loaded upper spring 2050 compresses the cam 2100 downwards until the cam 2100 overcomes another critical point, permitting the cam 2100 to rotate once again, as seen in FIG. 24e. The pressure from the compressed lower spring 2060 pushes the cam 2100 away from the tool 2002, allowing the tool 2002 to be propelled out with the remaining compression of the upper spring 2050, as seen in FIG. 24f.

Although this example describes ramps, slots, prongs, fins, and surfaces with a specific number of occurrences, in other implementations other numbers are used. For example, two or three or five ramps, slots, and prongs are used. In other implementations, three, four, or five fins are used.

In various implementations, once the tool 2002 is in the locked position for use, a space remains between the fins 2004 and the curved inner edge of the plunger 2200. In some implementations, this space provides a shock absorbing effect for the tool 2002. Before the tool 2002 can be removed, it must be pushed all the way to the top of plunger slot 2204, as described above. However, before reaching the critical point, compression of the upper and lower springs 2050, 2060 provides resistance when the tool 2002 encounters a substance. Thus, in some implementations, the tool 2002 displaces relative to the housing 2010, providing a proxy for applied force. In some implementations, the displacement is measured by a range sensor. In some implementations, this proxy for applied force, and resulting displacement. ensures a consistent density of gathered material in the tool (e.g., an evenly distributed amount of chemical powder throughout an auger tool). In some implementations, as an auger tool “digs” downward, a processor communicating with the range sensor will detect upward movement of the auger tool as material is removed from the immediate tip of the tool, and the processor may direct the positioning member to lower the arm (and thus the tool) further into the chemical material, ensuring a more constant force on the auger and more consistent material density. In various implementations, this process of detecting tool movement and adjusting the downward force experienced by the tool may be run continuously in a PID-type feedback loop.

### Example Description of One Implementation: Handheld Implementation of the Dispensing Head as a “Solids Dispensing Pipette”

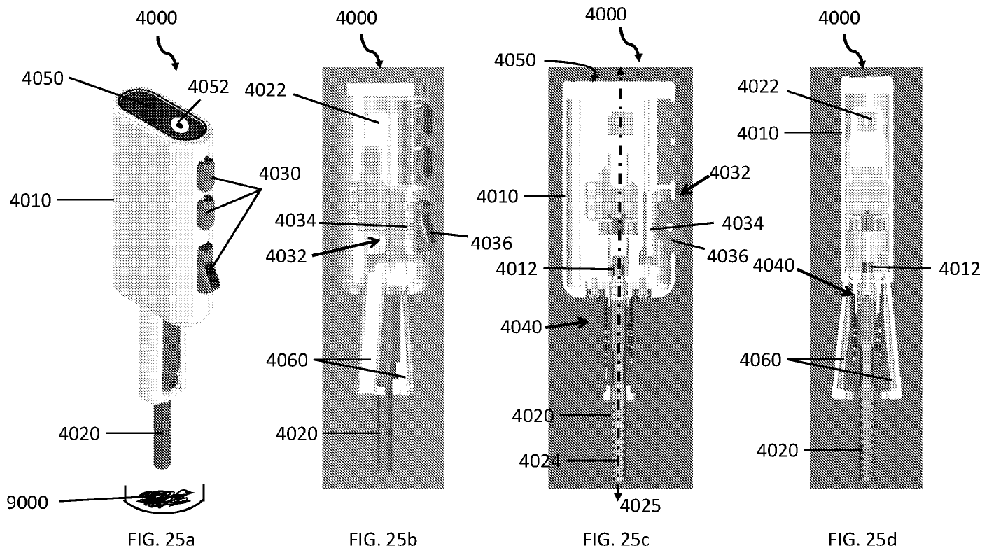

In various implementations, a device, method, and system of gathering and/or dispensing free-flowing material may be a handheld dispenser for solid materials. As shown in FIGS. 25a-d, a solids dispensing pipette 4000 is provided for handling solid chemical material (e.g., chemical powders) in a similar manner as the tool head and tools connected to the arm in above-described embodiments. The difference with solids dispensing pipette 4000 is the ability for a user to operate the device separate from or in conjunction with the overall system 1000.

In various implementations, the solids dispensing pipette 4000 takes advantage of many of the above-described mechanisms to collect, dispense, and measure free-flowing material 9000 (e.g., the auge tool). In various implementations, the solids dispensing pipette 4000 takes advantage of the connection mechanisms described above (e.g., the cam and thruster mechanism).

In various implementations, the solids dispensing pipette 4000 includes a housing 4010, a tool 4020, buttons 4030, a cam and thruster mechanism 4040), a user interface 4050, and linked arms 4060.

The tool 4020 is disposed on the lower side of the housing 4010. In some implementations, the tool 4020 is configured to gather free-flowing material 9000 (e.g., solid chemical powder) from a chemical container. A tool motor 4022 may drive the tool 4020, causing the auger screw 4024 to rotate about a tool axis 4025.

In some implementations, the solids dispensing pipette 4000 includes a cam and thruster mechanism 4040. The cam and thruster mechanism 4040 functions substantially the same as the above described cam and thruster mechanism (various tools may be attached or removed from the end of the device by applying a downward pressure which engages a cam, plunger, and fins to lock/unlock the tool).

In some implementations, buttons 4030 are disposed on the side of the housing 4010. Situations may arise where a user needs to release and discard a tool tip (e.g., an auger tip). In some implementations, a button-driven unlock cycle 4032 is provided. The mechanical linkage of the button-driven unlock cycle 4032 includes a rack and pinion 4034 attached to an unlock button 4036. The rack and pinion 4034 engages with two linked arms 4060 disposed around the tool 4020. Upon pushing the unlock button 4036, the rack and pinion 4034 of the button-driven unlock cycle 4032 engages with the two linked arms 4060. In some implementations, each linked arm 4060 swings outwards on the tool side and inwards on the housing side. The linked arms 4060 lift up and engage a tool unlock mechanism (e.g., the cam and thrust mechanism 4040) connected to the tool 4020). Thus, in some implementations, a user may press the unlock button 4036 so that the tool 4020 is primed to disengage from the solids dispensing pipette 4000 and free from the enclosure of links arms 4060. In some implementations, when a user releases unlock button 4036, the tool 4020 drops out of the device entirely (e.g., into a waste container). In some implementations, the unlock button 4036 and button-driven unlock cycle 4032 may include a lever or other mechanical linkage other than a rack and pinion.

In some implementations, a weighing scale normally present on a tool head is replaced with a smaller load cell 4012 used to measure amount of material gathered. The load cell 4012 sits mounted within the housing 4010 between the internal motor 4022 and the cam and thruster mechanism 4040).

In various implementations, a user interface 4050 is disposed on top of the housing 4010. The user interface 4050 may include a bubble level 4052 so that users may align the solids dispensing pipette 4000 with the gravity vector. In some implementations, the bubble level 4052 is a digital, 3-axis microelectromechanical system (MEMS) accelerometer with a 3-axis MEMS gyroscope for additional stability measurements. In some implementations, the user interface 4050 is an LCD or OLED screen. In some implementations, the current scale reading from the load cell 4012 may be displayed on the user interface 4050. In some implementations, one or more of the buttons 4030 are configured to control the solids dispensing pipette 4000.

In various implementations, the solids dispensing pipette 4000 has two modes of operation: “continuous” or “programmed.” In “continuous” mode, the tool motor 4022 drives the tool 4020 at a speed proportional to the force applied on a button 4030. In “programmed” mode, the tool motor 4022 drives the tool 4020 at a predefined speed automatically, based on predefined mass values or prior data.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A device for transferring free-flowing material, the device comprising:
a gantry;
an arm having an arm longitudinal axis, a first arm portion, a second arm portion spaced apart from the first arm portion along the arm longitudinal axis, and a middle arm portion disposed between the first arm portion and the second arm portion, wherein the middle arm portion is rotatably coupled to the gantry;
a gripper including two or more fingers movably coupled to the first arm portion relative to a gripper axis, wherein the two or more fingers are radially movable relative to the gripper axis between a first position and a second position, wherein at least two of the two or more fingers are closer to the gripper axis in the second position than in the first position; and
a tool head coupled to the second arm portion, wherein the tool head includes a tool head motor and a tool coupling portion that is couplable to a tool.

2. The device of claim 1, wherein the tool is an auger, wherein the tool head motor is configured to rotate the auger about an auger longitudinal axis.

3. The device of claim 1, further comprising a work surface defining a surface plane, wherein the gantry comprises a movable positioning member configured to move along an x-axis parallel to the surface plane, wherein the arm is coupled to the movable positioning member, and wherein the arm is configured to move vertically along a z-axis perpendicular to the surface plane and rotatably about the z-axis.

4. The device of claim 1, wherein the tool head is removably coupled to the second arm portion.

5. The device of claim 4, wherein the tool head defines one or more head coupling openings, wherein the device further comprises one or more head coupling protrusions coupled to the second arm portion, wherein each of the one or more head coupling protrusions is configured to be disposed within a different one of the one or more head coupling openings to removably couple the tool head to the second arm portion.

6. The device of claim 5, wherein the one or more head coupling openings and the tool coupling portion are defined by a first head side of the tool head, wherein the tool head further includes a rotatable locking plate, the locking plate defining one or more plate openings sized to receive the one or more head coupling protrusions, wherein the locking plate is rotatable from a locked position to an unlocked position, wherein the one or more head coupling protrusions are movable through the one or more plate openings into the one or more plate openings or out of the one or more plate openings in the unlocked position, and the one or more head coupling protrusions are blocked from moving through the one or more plate openings into the one or more plate openings or out of the one or more plate openings in the locked position.

7. The device of claim 6, wherein the tool head includes a guide element that is slidable by a ramp to move the locking plate between the locked position and the unlocked position.

8. The device of claim 1, wherein the tool coupling portion includes a cam and thruster mechanism for coupling the tool coupling portion to the tool.

9. The device of claim 1, wherein the two or more fingers are axially movable along the gripper axis.

10. The device of claim 9, further comprising a gripper actuator for causing the two or more fingers to axially move along the gripper axis.

11. The device of claim 9, wherein the gripper is movably coupled to the first arm portion by a gripper bearing such that the two or more fingers are axially movable along the gripper axis.

12. The device of claim 11, further comprising a gripper spring having a first spring end and a second spring end opposite the first spring end, wherein the first spring end is statically coupled to the first arm portion and the second spring end is statically coupled to the gripper.

13. The device of claim 12, wherein the spring is a first spring, the device further comprising a second spring having a first spring end and a second spring end opposite the first spring end, wherein the first spring end of the second spring is statically coupled to the first arm portion and the second spring end of the second spring is coupled to the gripper, wherein the first spring and the second spring bias the gripper in opposite directions.

14. The device of claim 1, wherein the two or more fingers are rotatable about the gripper axis.

15. The device of claim 1, further comprising:
a work surface defining a surface plane; and
an uncapping station disposed on the work surface, the uncapping station comprising:
an uncapping axis;
one or more uncapping fingers radially movable relative to the uncapping axis between a first position and a second position, wherein at least two of the two or more uncapping fingers are closer to the uncapping axis in the second position than in the first position, wherein the two or more fingers are rotatable about the uncapping axis.

16. The device of claim 1, wherein the gripper includes wherein the gripper includes a worm gear, a flange nut, and a vertical displacement device, wherein the worm gear is coupled to the flange nut and the flange nut is engaged with the vertical displacement device such that rotation of the worm gear causes the vertical displacement device to move each of the two or more fingers between the first position and the second position.

17. The device of claim 16, wherein the two or more fingers comprises four fingers.

18. The device of claim 1, further comprising a range sensor coupled to the second arm portion for determining the distance from the free-flowing material to the range sensor.

19. The device of claim 18, wherein the range sensor is coupled to the tool head.

20. The device of claim 18, wherein the range sensor comprises a time-of-flight sensor.

21. The device of claim 1, further comprising a weighing scale having a mass-sensitive portion and a non-mass-sensitive portion, wherein the non-mass-sensitive portion is coupled to the second arm portion and the mass-sensitive portion is coupled to the tool head.

22. The device of claim 21, further comprising a current sensor for sensing current flow of the tool head motor and a processor in electrical communication with the current sensor and a memory, wherein the processor executes computer-readable instructions stored on the memory, the instructions causing the processor to:
receive a first mass measurement from the weighing scale,
energize the tool head motor to cause the tool to collect a portion of the free-flowing material,
receive sensor data from the current sensor,
deenergize the tool head motor,
determine an amount of time the tool head motor was energized or the number of motor rotations,
receive a second mass measurement from the weighing scale, and
determine a flow consistency property of the free-flowing material based on the amount of time the tool head motor was energized or the number of motor rotations, the difference between the first mass measurement and the second mass measurement, and the sensor data from the current sensor.

23. The device of claim 22, further comprising a first infrared communication system in electrical communication with the processor and a second infrared communication system coupled to and in electrical communication with the tool head motor, wherein each of the first infrared communication system and the second infrared communication system include a transmitter and a receiver.

24. The device of claim 21, further comprising a processor in electrical communication with a memory, wherein the processor executes computer-readable instructions stored on the memory, the instructions causing the processor to:
receive a first mass measurement from the weighing scale,
move the arm along the z-axis such that the tool contacts the free-flowing material within a container,
energize the tool head motor to cause the tool to collect a portion of the free-flowing material,
deenergize the tool head motor,
move the arm along the z-axis such that the tool is spaced apart from the free-flowing material within the container,
determine a first amount of time the tool head motor was energized or the number of motor rotations,
receive a second mass measurement from the weighing scale, and
determine a first collection rate of the free-flowing material by the tool based on the amount of time the tool head motor was energized or the number of motor rotations and the difference between the first mass measurement and the second mass measurement.

25. The device of claim 24, wherein the instructions cause the processor to:
move the arm along the z-axis such that the tool contacts the free-flowing material within the container,
energize the tool head motor to cause the tool to collect another portion of the free-flowing material,
deenergize the tool head motor,
move the arm along the z-axis such that the tool is spaced apart from the free-flowing material within the container,
determine a second amount of time the tool head motor was energized or the number of motor rotations,
receive a third mass measurement from the weighing scale, and
determine a second collection rate of the free-flowing material by the tool based on the second amount of time the tool head motor was energized or the number of motor rotations and the difference between the second mass measurement and the third mass measurement.

26. The device of claim 24, further comprising a first infrared communication system in electrical communication with the processor and a second infrared communication system coupled to and in electrical communication with the tool head motor, wherein each of the first infrared communication system and the second infrared communication system include a transmitter and a receiver.

27. The device of claim 21, further comprising a first wireless power transmission (WPT) coil and a second WPT coil, wherein the first WPT coil is coupled to the second arm portion and the second WPT coil is coupled to the tool head, wherein the first WPT coil is spaced apart from the second WPT coil, and the first WPT coil is energizable to cause current to flow through the second WPT coil.

28. The device of claim 27, further comprising a battery in electrical communication with the second WPT coil such that the current to flow through the second WPT coil charges the battery.

29. The device of claim 27, wherein the first WPT coil is configured to deenergize when the weighing scale is in use.

30. The device of claim 1, further comprising a shaker coupled to the tool head for causing vibrations in the tool.

31. A weighing device, the device comprising:
a weighing scale having a mass-sensitive portion and a non-mass-sensitive portion, wherein the mass-sensitive portion is coupled to a tool head; and
a first wireless power transmission (WPT) coil and a second WPT coil, wherein the first WPT coil is coupled to the mass-sensitive portion and the second WPT coil is coupled to the non-mass-sensitive portion, wherein the first WPT coil is spaced apart from the second WPT coil, and the first WPT coil is energizable to cause current to flow through the second WPT coil and to the tool head.

32. The device of claim 31, further comprising a battery in electrical communication with the second WPT coil such that the current to flow through the second WPT coil charges the battery.

33. The device of claim 31, wherein the first WPT coil is configured to deenergize when the weighing scale is in use.

34. The device of claim 31, wherein the tool head includes a tool head motor and a tool coupling portion that is couplable to a tool, wherein the current to flow through the second WPT coil flows to the tool head motor.

35. The device of claim 34, wherein the tool is an auger, wherein the tool head motor is configured to rotate the auger about an auger longitudinal axis.

36. The device of claim 34, wherein the tool head is removably coupled to the mass-sensitive portion.

37. The device of claim 36, wherein the tool head defines one or more head coupling openings, wherein the device further comprises one or more head coupling protrusions coupled to the mass-sensitive portion, wherein each of the one or more head coupling protrusions is configured to be disposed within a different one of the one or more head coupling openings to removably couple the tool head to the mass-sensitive portion.

38. The device of claim 37, wherein the one or more head coupling openings and the tool coupling portion are defined by a first head side, wherein the tool head further includes a rotatable locking plate, the locking plate defining one or more plate openings sized to receive the one or more head coupling protrusions, wherein the locking plate is rotatable from a locked position to an unlocked position, wherein the one or more head coupling protrusions are movable through the one or more plate openings into the one or more plate openings or out of the one or more plate openings in the unlocked position, and the one or more head coupling protrusions are blocked from moving through the one or more plate openings into the one or more plate openings or out of the one or more plate openings in the locked position.

39. The device of claim 38, wherein the tool head includes a guide element that is slidable by a ramp to move the locking plate between the locked position and the unlocked position.

40. The device of claim 31, wherein the tool coupling portion includes a cam and thruster mechanism for coupling the tool coupling portion to the tool.

41. The device of claim 31, further comprising a range sensor coupled to the mass-sensitive portion for determining the distance from a free-flowing material to the range sensor.

42. The device of claim 41, wherein the range sensor is coupled to the tool head.

43. The device of claim 41, wherein the range sensor comprises a time-of-flight sensor.

44. The device of claim 34, further comprising a current sensor for sensing current flow of the tool head motor and a processor in electrical communication with the current sensor and a memory, wherein the processor executes computer-readable instructions stored on the memory, the instructions causing the processor to:
receive a first mass measurement from the weighing scale,
energize the tool head motor to cause the tool to collect a portion of a free-flowing material,
receive sensor data from the current sensor,
deenergize the tool head motor,
determine an amount of time the tool head motor was energized or the number of motor rotations,
receive a second mass measurement from the weighing scale, and
determine a flow consistency property of the free-flowing material based on the amount of time the tool head motor was energized or the number of motor rotations, the difference between the first mass measurement and the second mass measurement, and the sensor data from the current sensor.

45. The device of claim 44, further comprising a first infrared communication system in electrical communication with the processor and a second infrared communication system coupled to and in electrical communication with the tool head motor, wherein each of the first infrared communication system and the second infrared communication system include a transmitter and a receiver.

46. The device of claim 34, further comprising a processor in electrical communication with a memory, wherein the processor executes computer-readable instructions stored on the memory, the instructions causing the processor to:
receive a first mass measurement from the weighing scale,
cause the tool head to move such that the tool contacts a free-flowing material within a container,
energize the tool head motor to cause the tool to collect a portion of the free-flowing material,
deenergize the tool head motor,
cause the tool head to move such that the tool is spaced apart from the free-flowing material within the container,
determine a first amount of time the tool head motor was energized or the number of motor rotations,
receive a second mass measurement from the weighing scale, and
determine a first collection rate of the free-flowing material by the tool based on the amount of time the tool head motor was energized or the number of motor rotations and the difference between the first mass measurement and the second mass measurement.

47. The device of claim 46, wherein the instructions cause the processor to:
cause the tool head to move such that the tool contacts the free-flowing material within the container,
energize the tool head motor to cause the tool to collect another portion of the free-flowing material,
deenergize the tool head motor,
cause the tool head to move such that the tool is spaced apart from the free-flowing material within the container,
determine a second amount of time the tool head motor was energized or the number of motor rotations,
receive a third mass measurement from the weighing scale, and
determine a second collection rate of the free-flowing material by the tool based on the second amount of time the tool head motor was energized or the number of motor rotations and the difference between the second mass measurement and the third mass measurement.

48. The device of claim 46, further comprising a first infrared communication system in electrical communication with the processor and a second infrared communication system coupled to and in electrical communication with the tool head motor, wherein each of the first infrared communication system and the second infrared communication system include a transmitter and a receiver.

49. A tool head removal device, the device comprising:
a base including one or more head coupling protrusions; and
a tool head removably coupled to the base, wherein the tool head includes a tool head motor and a tool coupling portion that is couplable to a tool, wherein the tool head defines one or more head coupling openings,
wherein each of the one or more head coupling protrusions is configured to be disposed within a different one of the one or more head coupling openings to removably couple the tool head to the base.

50. The device of claim 49, wherein the one or more head coupling openings and the tool coupling portion are defined by a first head side of the tool head, wherein the tool head further includes a rotatable locking plate, the locking plate defining one or more plate openings sized to receive the one or more head coupling protrusions, wherein the locking plate is rotatable from a locked position to an unlocked position, wherein the one or more head coupling protrusions are movable through the one or more plate openings into the one or more plate openings or out of the one or more plate openings in the unlocked position, and the one or more head coupling protrusions are blocked from moving through the one or more plate openings into the one or more plate openings or out of the one or more plate openings in the locked position.

51. The device of claim 50, wherein the tool head includes a guide element that is slidable by a ramp to move the locking plate between the locked position and the unlocked position.

52. The device of claim 49, wherein the tool coupling portion includes a cam and thruster mechanism for coupling the tool coupling portion to the tool.

53. The device of claim 49, further comprising a range sensor coupled to the base for determining the distance from a free-flowing material to the range sensor.

54. The device of claim 53, wherein the range sensor comprises a time-of-flight sensor.

55. The device of claim 49, further comprising a range sensor coupled to the tool head for determining the distance from a free-flowing material to the range sensor.

56. The device of claim 55, wherein the range sensor comprises a time-of-flight sensor.

57. The device of claim 49, wherein the tool is an auger, wherein the tool head motor is configured to rotate the auger about an auger longitudinal axis.

58. The device of claim 49, wherein the base is an end portion of an arm coupled to a movable positioning member.

59. The device of claim 58, further comprising:
a work surface defining a surface plane, and
a gantry comprising a movable positioning member configured to move along an x-axis parallel to the surface plane, wherein the arm is coupled to the movable positioning member, and wherein the arm is configured to move vertically along a z-axis perpendicular to the surface plane and rotatably about the z-axis.

60. The device of claim 49, further comprising a weighing scale having a mass-sensitive portion and a non-mass-sensitive portion, wherein the non-mass-sensitive portion is coupled to the base and the mass-sensitive portion is coupled to the one or more head coupling protrusions.

61. The device of claim 60, further comprising a current sensor for sensing current flow of the tool head motor and a processor in electrical communication with the current sensor and a memory, wherein the processor executes computer-readable instructions stored on the memory, the instructions causing the processor to:
receive a first mass measurement from the weighing scale,
energize the tool head motor to cause the tool to collect a portion of a free-flowing material,
receive sensor data from the current sensor,
deenergize the tool head motor,
determine an amount of time the tool head motor was energized or the number of motor rotations,
receive a second mass measurement from the weighing scale, and
determine a flow consistency property of the free-flowing material based on the amount of time the tool head motor was energized or the number of motor rotations, the difference between the first mass measurement and the second mass measurement, and the sensor data from the current sensor.

62. The device of claim 61, further comprising a first infrared communication system in electrical communication with the processor and a second infrared communication system coupled to and in electrical communication with the tool head motor, wherein each of the first infrared communication system and the second infrared communication system include a transmitter and a receiver.

63. The device of claim 60, further comprising a processor in electrical communication with a memory, wherein the processor executes computer-readable instructions stored on the memory, the instructions causing the processor to:
receive a first mass measurement from the weighing scale,
cause the tool head to move such that the tool contacts a free-flowing material within a container,
energize the tool head motor to cause the tool to collect a portion of the free-flowing material,
deenergize the tool head motor,
cause the tool head to move such that the tool is spaced apart from the free-flowing material within the container,
determine a first amount of time the tool head motor was energized or the number of motor rotations,
receive a second mass measurement from the weighing scale, and
determine a first collection rate of the free-flowing material by the tool based on the amount of time the tool head motor was energized or the number of motor rotations and the difference between the first mass measurement and the second mass measurement.

64. The device of claim 63, wherein the instructions cause the processor to:
cause the tool head to move such that the tool contacts the free-flowing material within the container,
energize the tool head motor to cause the tool to collect another portion of the free-flowing material,
deenergize the tool head motor,
cause the tool head to move such that the tool is spaced apart from the free-flowing material within the container,
determine a second amount of time the tool head motor was energized or the number of motor rotations,
receive a third mass measurement from the weighing scale, and
determine a second collection rate of the free-flowing material by the tool based on the second amount of time the tool head motor was energized or the number of motor rotations and the difference between the second mass measurement and the third mass measurement.

65. The device of claim 63, further comprising a first infrared communication system in electrical communication with the processor and a second infrared communication system coupled to and in electrical communication with the tool head motor, wherein each of the first infrared communication system and the second infrared communication system include a transmitter and a receiver.

66. The device of claim 60, further comprising a first wireless power transmission (WPT) coil and a second WPT coil, wherein the first WPT coil is coupled to the base and the second WPT coil is coupled to the tool head, wherein the first WPT coil is spaced apart from the second WPT coil, and the first WPT coil is energizable to cause current to flow through the second WPT coil.

67. The device of claim 66, further comprising a battery in electrical communication with the second WPT coil such that the current to flow through the second WPT coil charges the battery.

68. The device of claim 66, wherein the first WPT coil is configured to deenergize when the weighing scale is in use.

69. The device of claim 49, further comprising a shaker coupled to the tool head for causing vibrations in the tool.

70. A tool removal device, the device comprising:
a base;
a tool; and
a tool head coupled to the base, wherein the tool head includes a tool head motor and a tool coupling portion that is couplable to the tool,
wherein the tool coupling portion includes a cam and thruster mechanism for coupling the tool coupling portion to the tool.

71. The device of claim 70, wherein the tool head is removably coupled to the second arm portion.

72. The device of claim 71, wherein the tool head defines one or more head coupling openings, wherein the device further comprises one or more head coupling protrusions coupled to the base, wherein each of the one or more head coupling protrusions is configured to be disposed within a different one of the one or more head coupling openings to removably couple the tool head to the base.

73. The device of claim 72, wherein the one or more head coupling openings and the tool coupling portion are defined by a first head side of the tool head, wherein the tool head further includes a rotatable locking plate, the locking plate defining one or more plate openings sized to receive the one or more head coupling protrusions, wherein the locking plate is rotatable from a locked position to an unlocked position, wherein the one or more head coupling protrusions are movable through the one or more plate openings into the one or more plate openings or out of the one or more plate openings in the unlocked position, and the one or more head coupling protrusions are blocked from moving through the one or more plate openings into the one or more plate openings or out of the one or more plate openings in the locked position.

74. The device of claim 73, wherein the tool head includes a guide element that is slidable by a ramp to move the locking plate between the locked position and the unlocked position.

75. The device of claim 70, further comprising a range sensor coupled to the base for determining the distance from a free-flowing material to the range sensor.

76. The device of claim 75, wherein the range sensor comprises a time-of-flight sensor.

77. The device of claim 70, further comprising a range sensor coupled to the tool head for determining the distance from a free-flowing material to the range sensor.

78. The device of claim 77, wherein the range sensor comprises a time-of-flight sensor.

79. The device of claim 70, wherein the tool is an auger, wherein the tool head motor is configured to rotate the auger about an auger longitudinal axis.

80. The device of claim 70, wherein the base is an end portion of an arm coupled to a movable positioning member.

81. The device of claim 80, further comprising:
a work surface defining a surface plane, and
a gantry comprising a movable positioning member configured to move along an x-axis parallel to the surface plane, wherein the arm is coupled to the movable positioning member, and wherein the arm is configured to move vertically along a z-axis perpendicular to the surface plane and rotatably about the z-axis.

82. The device of claim 70, further comprising a weighing scale having a mass-sensitive portion and a non-mass-sensitive portion, wherein the non-mass-sensitive portion is coupled to the base and the mass-sensitive portion is coupled to the tool head.

83. The device of claim 82, further comprising a current sensor for sensing current flow of the tool head motor and a processor in electrical communication with the current sensor and a memory, wherein the processor executes computer-readable instructions stored on the memory, the instructions causing the processor to:
receive a first mass measurement from the weighing scale,
energize the tool head motor to cause the tool to collect a portion of a free-flowing material,
receive sensor data from the current sensor,
deenergize the tool head motor,
determine an amount of time the tool head motor was energized or the number of motor rotations,
receive a second mass measurement from the weighing scale, and
determine a flow consistency property of the free-flowing material based on the amount of time the tool head motor was energized or the number of motor rotations, the difference between the first mass measurement and the second mass measurement, and the sensor data from the current sensor.

84. The device of claim 83, further comprising a first infrared communication system in electrical communication with the processor and a second infrared communication system coupled to and in electrical communication with the tool head motor, wherein each of the first infrared communication system and the second infrared communication system include a transmitter and a receiver.

85. The device of claim 82, further comprising a processor in electrical communication with a memory, wherein the processor executes computer-readable instructions stored on the memory, the instructions causing the processor to:
receive a first mass measurement from the weighing scale,
cause the tool head to move such that the tool contacts a free-flowing material within a container,
energize the tool head motor to cause the tool to collect a portion of the free-flowing material,
deenergize the tool head motor,
cause the tool head to move such that the tool is spaced apart from the free-flowing material within the container,
determine a first amount of time the tool head motor was energized or the number of motor rotations,
receive a second mass measurement from the weighing scale, and
determine a first collection rate of the free-flowing material by the tool based on the amount of time the tool head motor was energized or the number of motor rotations and the difference between the first mass measurement and the second mass measurement.

86. The device of claim 85, wherein the instructions cause the processor to:
cause the tool head to move such that the tool contacts the free-flowing material within the container,
energize the tool head motor to cause the tool to collect another portion of the free-flowing material,
deenergize the tool head motor,
cause the tool head to move such that the tool is spaced apart from the free-flowing material within the container,
determine a second amount of time the tool head motor was energized or the number of motor rotations,
receive a third mass measurement from the weighing scale, and
determine a second collection rate of the free-flowing material by the tool based on the second amount of time the tool head motor was energized or the number of motor rotations and the difference between the second mass measurement and the third mass measurement.

87. The device of claim 85, further comprising a first infrared communication system in electrical communication with the processor and a second infrared communication system coupled to and in electrical communication with the tool head motor, wherein each of the first infrared communication system and the second infrared communication system include a transmitter and a receiver.

88. The device of claim 82, further comprising a first wireless power transmission (WPT) coil and a second WPT coil, wherein the first WPT coil is coupled to the base and the second WPT coil is coupled to the tool head, wherein the first WPT coil is spaced apart from the second WPT coil, and the first WPT coil is energizable to cause current to flow through the second WPT coil.

89. The device of claim 88, further comprising a battery in electrical communication with the second WPT coil such that the current to flow through the second WPT coil charges the battery.

90. The device of claim 88, wherein the first WPT coil is configured to deenergize when the weighing scale is in use.

91. The device of claim 70, further comprising a shaker coupled to the tool head for causing vibrations in the tool.

92. A gripping device, the device comprising:
a base;
a gripper including two or more fingers movably coupled to the base relative to a gripper axis, wherein the two or more fingers are radially movable relative to the gripper axis between a first position and a second position, wherein at least two of the two or more fingers are closer to the gripper axis in the second position than in the first position, wherein the two or more fingers are axially movable along the gripper axis; and
a gripper spring having a first spring end and a second spring end opposite the first spring end, wherein the first spring end is statically coupled to the base and the second spring end is statically coupled to the gripper.

93. The device of claim 92, further comprising a gripper actuator for causing the two or more fingers to axially move along the gripper axis.

94. The device of claim 92, wherein the gripper is movably coupled to the base by a gripper bearing such that the two or more fingers are axially movable along the gripper axis.

95. The device of claim 92, wherein the spring is a first spring, the device further comprising a second spring having a first spring end and a second spring end opposite the first spring end, wherein the first spring end of the second spring is statically coupled to the base and the second spring end of the second spring is coupled to the gripper, wherein the first spring and the second spring bias the gripper in opposite directions.

96. The device of claim 92, wherein the two or more fingers are rotatable about the gripper axis.

97. The device of claim 92, further comprising a work surface defining a surface plane.

98. The device of claim 97, further comprising an uncapping station disposed on the work surface, the uncapping station comprising:
an uncapping axis;
one or more uncapping fingers radially movable relative to the uncapping axis between a first position and a second position, wherein at least two of the two or more uncapping fingers are closer to the uncapping axis in the second position than in the first position, wherein the two or more fingers are rotatable about the uncapping axis.

99. The device of claim 92, wherein the gripper includes a worm gear, a flange nut, and a vertical displacement device, wherein the worm gear is coupled to the flange nut and the flange nut is engaged with the vertical displacement device such that rotation of the worm gear causes the vertical displacement device to move each of the two or more fingers between the first position and the second position.

100. The device of claim 99, wherein the two or more fingers comprises four fingers.

101. The device of claim 92, wherein the base is an end portion of an arm coupled to a gantry.

102. The device of claim 101, further comprising:
a work surface defining a surface plane, and
a gantry comprising a movable positioning member configured to move along an x-axis parallel to the surface plane, wherein the arm is coupled to the movable positioning member, and wherein the arm is configured to move vertically along a z-axis perpendicular to the surface plane and rotatably about the z-axis.

103. An uncapping system, the system comprising:
a work surface defining a surface plane;
a gripping device, the device comprising:
a base, and
a gripper including two or more fingers movably coupled to the base relative to a gripper axis, wherein the two or more fingers are radially movable relative to the gripper axis between a first position and a second position, wherein at least two of the two or more fingers are closer to the gripper axis in the second position than in the first position; and;
an uncapping station disposed on the work surface, the uncapping station comprising:
an uncapping axis,
one or more uncapping fingers radially movable relative to the uncapping axis between a first position and a second position, wherein at least two of the two or more uncapping fingers are closer to the uncapping axis in the second position than in the first position, wherein the two or more fingers are rotatable about the uncapping axis.

104. The device of claim 103, wherein the two or more fingers are axially movable along the gripper axis.

105. The device of claim 104, further comprising a gripper actuator for causing the two or more fingers to axially move along the gripper axis.

106. The device of claim 104, wherein the gripper is movably coupled to the base by a gripper bearing such that the two or more fingers are axially movable along the gripper axis.

107. The device of claim 106, further comprising a gripper spring having a first spring end and a second spring end opposite the first spring end, wherein the first spring end is statically coupled to the first arm portion and the second spring end is statically coupled to the gripper.

108. The device of claim 107, wherein the spring is a first spring, the device further comprising a second spring having a first spring end and a second spring end opposite the first spring end, wherein the first spring end of the second spring is statically coupled to the base and the second spring end of the second spring is coupled to the gripper, wherein the first spring and the second spring bias the gripper in opposite directions.

109. The device of claim 103, wherein the two or more fingers are rotatable about the gripper axis.

110. The device of claim 103, wherein the gripper includes a worm gear, a flange nut, and a vertical displacement device, wherein the worm gear is coupled to the flange nut and the flange nut is engaged with the vertical displacement device such that rotation of the worm gear causes the vertical displacement device to move each of the two or more fingers between the first position and the second position.

111. The device of claim 110, wherein the two or more fingers comprises four fingers.

112. The device of claim 103, wherein the base is an end portion of an arm coupled to a movable positioning member.

113. The device of claim 112, further comprising:
a work surface defining a surface plane, and
a gantry comprising a movable positioning member configured to move along an x-axis parallel to the surface plane, wherein the arm is coupled to the movable positioning member, and wherein the arm is configured to move vertically along a z-axis perpendicular to the surface plane and rotatably about the z-axis.

114. A reactor system, the system comprising:
a reactor core configured to receive one or more containers for containing a chemical reaction, the reactor core having a first core side and a second core side opposite and spaced apart from the first core side; and
an outer support structure comprising:
a frame having a first frame portion, a second frame portion spaced apart and opposite the first frame portion, and at least one side frame portion extending from the first frame portion to the second frame portion,
a frame longitudinal axis extending from the first frame portion to the second frame portion,
a first resilient member extending from the first frame portion to the first core side,
a second frame resilient member extending from the second frame portion to the second core side such that the reactor core is disposed between the first frame portion and the second frame portion and is suspended by the first frame resilient member and the second frame resilient member,
at least one actuator extending from the frame to the reactor core, wherein the actuator is movable from an extended position to a retracted position to cause the reactor core to move radially relative to the frame longitudinal axis.

115. The reactor system of claim 114, wherein the at least one actuator comprises at least two actuators.

116. The reactor system of claim 115, wherein the at least two actuators comprises at least three actuators.

117. The reactor system of claim 114, wherein the at least one actuator comprises at least one linear actuator.

118. The reactor system of claim 114, wherein the outer support structure comprises at least one cable coupling the at least one actuator to the reactor core.

119. The reactor system of claim 116, further comprising a processor in electrical communication with the at least three actuators and a memory, wherein the processor executes computer-readable instructions stored on the memory, the instructions causing the processor to:
send a signal to a first actuator of the at least three actuators to cause the first actuator to move from the extended position to the retracted position;
send a signal to a second actuator of the at least three actuators to cause the second actuator to move from the extended position to the retracted position;
send a signal to the first actuator to cause the first actuator to move from the retracted position to the extended position;
send a signal to a third actuator of the at least three actuators to cause the third actuator to move from the extended position to the retracted position;
send a signal to the second actuator to cause the second actuator to move from the retracted position to the extended position; and
send a signal to the third actuator to cause the this actuator to move from the retracted position to the extended position.

120. The reactor system of claim 114, wherein the reactor core further comprises:
a body defining a container opening for receiving the container for containing the chemical reaction, wherein the container opening defines a container longitudinal axis; and
a door system comprising:
a door for sealingly abutting a lip of an opening defined by the container disposed within the container opening;
a door hinge coupled to the door; and
a door lift coupled to the door hinge such that the door is hingable by the door hinge relative to the door lift, wherein the door lift is configured to move the door along the container longitudinal axis relative to the body.

121. The reactor system of claim 120, wherein the container opening is a first container opening, the body defining one or more additional container openings, wherein the door system is a first door system, wherein the reactor core further comprises one or more additional door systems, wherein the door of each of the one or more additional door systems is configured to sealingly abutting a lip of an opening defined by a container disposed within a different one of the one or more additional container openings.

122. The reactor system of claim 120, wherein the reactor core further comprises a door hinge motor for causing the door hinge to hinge the door relative to the door lift.

123. The reactor system of claim 120, wherein the reactor core further comprises a door lift motor for causing the door lift to move the door along the container longitudinal axis relative to the body.

124. The reactor system of claim 120, wherein the reactor core further comprises a rack and a pinion, wherein one of the rack or the pinion are coupled to the body and the other of the pinion or the rack is coupled to the door lift.

125. The reactor system of claim 120, wherein the door system further comprises a door lock including a lock protrusion movable from a locked position to an unlocked position, wherein the lock protrusion is engaged with a lock opening defined by the door to prevent hinging or movement of the door in the locked position, wherein the lock protrusion is disengaged with the lock opening in the unlocked position.

126. The reactor system of claim 125, wherein the door lock further includes a lock shaft having a lock longitudinal axis, wherein the lock protrusion extends radially from the lock shaft relative to the lock longitudinal axis, wherein the movement of the lock protrusion is circumferential rotation relative to the lock longitudinal axis.

127. The reactor system of claim 125, wherein the door lock further includes a lock plate defining a lock opening aligned with the container opening, wherein the lock opening includes a retaining portion and a releasing portion, wherein the retaining portion has a narrowest width that is narrower than a widest diameter of the container and the releasing portion has a narrowest width that is wider than the widest diameter of the container, wherein the retaining portion of the lock opening is aligned with the container opening in the unlocked position and the releasing portion of the lock opening is aligned with the container opening in the locked position.

128. The reactor system of claim 125, wherein the door lock further includes a lock motor for moving the lock protrusion from the locked position to the unlocked position.

129. The reactor system of claim 128, wherein the door lock further includes a lift lock engageable with the door lift, wherein in the locked position the lift lock is engaged with the door lift to prevent movement of the door along the container longitudinal axis relative to the body, wherein is the unlocked position the lift lock is disengaged with the door lift.

130. The reactor system of claim 120, wherein the reactor core further comprises an outer condenser comprising:
a condensing fluid reservoir in thermal contact with a container when the container is disposed in the container opening;
an outer condenser inlet in fluid communication with the condensing fluid reservoir; and
an outer condenser outlet in fluid communication with the condensing fluid reservoir.

131. The reactor system of claim 120, wherein the reactor core further comprises an inner condenser comprising:
a condenser coil coupled to the door such that the condenser coil is disposed within the container when the door is sealingly abutting the lip of the opening defined by the container when the container is disposed within the container opening;
an inner condenser inlet in fluid communication with the condensing fluid reservoir; and
an inner condenser outlet in fluid communication with the condensing fluid reservoir.

132. The reactor system of claim 120, wherein the reactor core further comprises one or more thermoelectric units in thermal contact with the container when the container is disposed within the container opening.

133. The reactor system of claim 132, wherein the reactor core further comprises a temperature sensor in thermal contact with thermoelectric unit.

134. The reactor system of claim 132, wherein the reactor core further comprises a heat exchanger comprising:
a heat exchange fluid reservoir in thermal contact with the one or more thermoelectric units;
a heat exchanger inlet in fluid communication with the heat exchange fluid reservoir; and
a heat exchanger outlet in fluid communication with the heat exchange fluid reservoir.

135. The reactor system of claim 120, wherein the reactor core further comprises:
a laser device configured to emit a laser through at least a portion of the container when the container is disposed within the container opening; and
a photodetector for receiving the emitted laser.

136. The reactor system of claim 120, wherein the reactor core further comprises a photo-optic circuit board for emitting light into the container when the container is disposed within the container opening.

137. The reactor system of claim 136, wherein the photo-optic circuit board is capable of emitting a range of wavelengths of light into the container when the container is disposed within the container opening.

138. A reactor core comprising:
a body defining a container opening for receiving a container for containing a chemical reaction, wherein the container opening defines a container longitudinal axis; and
a door system comprising:
a door for sealingly abutting a lip of an opening defined by the container disposed within the container opening;
a door hinge coupled to the door; and
a door lift coupled to the door hinge such that the door is hingable by the door hinge relative to the door lift, wherein the door lift is configured to move the door along the container longitudinal axis relative to the body.

139. The reactor core of claim 138, wherein the container opening is a first container opening, the body defining one or more additional container openings, wherein the door system is a first door system, further comprising one or more additional door systems, wherein the door of each of the one or more additional door systems is configured to sealingly abutting a lip of an opening defined by a container disposed within a different one of the one or more additional container openings.

140. The reactor core of claim 138, further comprising a door hinge motor for causing the door hinge to hinge the door relative to the door lift.

141. The reactor core of claim 138, further comprising a door lift motor for causing the door lift to move the door along the container longitudinal axis relative to the body.

142. The reactor core of claim 138, further comprising a rack and a pinion, wherein one of the rack or the pinion are coupled to the body and the other of the pinion or the rack is coupled to the door lift.

143. The reactor core of claim 138, wherein the door system further comprises a door lock including a lock protrusion movable from a locked position to an unlocked position, wherein the lock protrusion is engaged with a lock opening defined by the door to prevent hinging or movement of the door in the locked position, wherein the lock protrusion is disengaged with the lock opening in the unlocked position.

144. The reactor core of claim 143, wherein the door lock further includes a lock shaft having a lock longitudinal axis, wherein the lock protrusion extends radially from the lock shaft relative to the lock longitudinal axis, wherein the movement of the lock protrusion is circumferential rotation relative to the lock longitudinal axis.

145. The reactor core of claim 143, wherein the door lock further includes a lock plate defining a lock opening aligned with the container opening, wherein the lock opening includes a retaining portion and a releasing portion, wherein the retaining portion has a narrowest width that is narrower than a widest diameter of the container and the releasing portion has a narrowest width that is wider than the widest diameter of the container, wherein the retaining portion of the lock opening is aligned with the container opening in the unlocked position and the releasing portion of the lock opening is aligned with the container opening in the locked position.

146. The reactor core of claim 143, wherein the door lock further includes a lock motor for moving the lock protrusion from the locked position to the unlocked position.

147. The reactor core of claim 146, wherein the door lock further includes a lift lock engageable with the door lift, wherein in the locked position the lift lock is engaged with the door lift to prevent movement of the door along the container longitudinal axis relative to the body, wherein is the unlocked position the lift lock is disengaged with the door lift.

148. The reactor core of claim 138, further comprising an outer condenser comprising:
a condensing fluid reservoir in thermal contact with a container when the container is disposed in the container opening;
an outer condenser inlet in fluid communication with the condensing fluid reservoir; and
an outer condenser outlet in fluid communication with the condensing fluid reservoir.

149. The reactor core of claim 138, further comprising an inner condenser comprising:
a condenser coil coupled to the door such that the condenser coil is disposed within the container when the door is sealingly abutting the lip of the opening defined by the container when the container is disposed within the container opening;
an inner condenser inlet in fluid communication with the condensing fluid reservoir; and
an inner condenser outlet in fluid communication with the condensing fluid reservoir.

150. The reactor core of claim 138, further comprising one or more thermoelectric units in thermal contact with the container when the container is disposed within the container opening.

151. The reactor core of claim 150, further comprising a temperature sensor in thermal contact with thermoelectric unit.

152. The reactor core of claim 150, further comprising a heat exchanger comprising:
a heat exchange fluid reservoir in thermal contact with the one or more thermoelectric units;
a heat exchanger inlet in fluid communication with the heat exchange fluid reservoir; and
a heat exchanger outlet in fluid communication with the heat exchange fluid reservoir.

153. The reactor core of claim 138, further comprising:
a laser device configured to emit a laser through at least a portion of the container when the container is disposed within the container opening; and
a photodetector for receiving the emitted laser.

154. The reactor core of claim 138, further comprising a photo-optic circuit board for emitting light into the container when the container is disposed within the container opening.

155. The reactor core of claim 154, wherein the photo-optic circuit board is capable of emitting a range of wavelengths of light into the container when the container is disposed within the container opening.

156. A reactor system, the system comprising:
the reactor core of claim 138, the reactor core having a first core side and a second core side opposite and spaced apart from the first core side; and
an outer support structure comprising:
a frame having a first frame portion, a second frame portion spaced apart and opposite the first frame portion, and at least one side frame portion extending from the first frame portion to the second frame portion,
a frame longitudinal axis extending from the first frame portion to the second frame portion,
a first resilient member extending from the first frame portion to the first core side,
a second frame resilient member extending from the second frame portion to the second core side such that the reactor core is disposed between the first frame portion and the second frame portion and is suspended by the first frame resilient member and the second frame resilient member,
at least one actuator extending from the frame to the reactor core, wherein the actuator is movable from an extended position to a retracted position to cause the reactor core to move radially relative to the frame longitudinal axis.

157. The reactor system of claim 156, wherein the at least one actuator comprises at least two actuators.

158. The reactor system of claim 157, wherein the at least two actuators comprises six actuators.

159. The reactor system of claim 156, wherein the at least one actuator comprises at least one linear actuator.

160. The reactor system of claim 156, wherein the outer support structure comprises at least one cable coupling the at least one actuator to the reactor core.

161. The reactor system of claim 156, further comprising a processor in electrical communication with the at least three actuators and a memory, wherein the processor executes computer-readable instructions stored on the memory, the instructions causing the processor to:
send a signal to a first actuator of the at least three actuators to cause the first actuator to move from the extended position to the retracted position;
send a signal to a second actuator of the at least three actuators to cause the second actuator to move from the extended position to the retracted position;
send a signal to the first actuator to cause the first actuator to move from the retracted position to the extended position;
send a signal to a third actuator of the at least three actuators to cause the third actuator to move from the extended position to the retracted position;
send a signal to the second actuator to cause the second actuator to move from the retracted position to the extended position; and
send a signal to the third actuator to cause the third actuator to move from the retracted position to the extended position.
